(19) United States
(12) Patent Application Publication
(10) Pub. No.: US 2025/0383576 A1
(43) Pub. Date: Dec. 18, 2025

(54) MICROCELLS FOR ELECTROPHORETIC DISPLAYS AND METHODS OF PREPARING THE SAME

(71) Applicant: E Ink Corporation, Billerica, MA (US)

(72) Inventors: Weidong Li, Fremont, CA (US); Donald A. Schultz, San Jose, CA (US); Trung Quoc Nguyen, Fremont, CA (US); Du Quy Le, San Jose, CA (US); Yih-Ming Kang, Fremont, CA (US); Hongmei Zang, Fremont, CA (US); Stephen J. Telfer, Arlington, MA (US)

(21) Appl. No.: 19/237,792

(22) Filed: Jun. 13, 2025

Related U.S. Application Data
(60) Provisional application No. 63/659,526, filed on Jun. 13, 2024.

(51) Int. Cl. G02F 1/1681; G02F 1/167; G02F 1/1675; G02F 1/1676

(52) U.S. Cl. CPC G02F 1/1681; G02F 1/167; G02F 1/1676; G02F 2001/1678

(57) ABSTRACT

Electrophoretic displays comprising an electrophoretic media layer including a film of microcells and methods of preparing the same are disclosed. Desirable electric optical performances and coating quality can be achieved by the electrophoretic displays disclosed herein.

### CROSS REFERENCE TO RELATED APPLICATIONS

This application claims the benefit of priority of U.S. Provisional Patent Application Ser. No. 63/659,526, filed Jun. 13, 2024, the content of which is incorporated by reference in its entirety.

### BACKGROUND OF THE INVENTION

The electrophoretic display (EPD) is a non-emissive device based on the electrophoresis phenomenon of charged pigment particles suspended in a solvent. The display usually comprises two substrates with electrodes placed opposing each other. One of the electrodes is usually transparent. A suspension composed of a solvent and charged pigment particles is enclosed between the two plates. Typically, the suspension is encapsulated in microcapsules or within microcells, e.g., embossed microcells. When a voltage difference is imposed between the two electrodes, the pigment particles migrate between the electrodes such that a color of a pigment is visible at the viewing surface, according to the polarity and magnitude of the applied voltage. In some instances, a combination of pigments is viewable at the surface. Preferably, the electrophoretic display is bistable (multi-stable) in that it does not require energy to maintain the image.

In order to prevent sedimentation, partitions between the two electrodes are used to divide the space into smaller compartments. In a microcell electrophoretic display, the charged particles and the fluid are retained within a plurality of cavities formed within a carrier medium, typically a polymeric film. See, for example, U.S. Pat. Nos. 6,672,921 and 6,788,449. The microcells are also known in the literature as microcavities or microcups. The EPD comprises isolated cells formed from microcells of well-defined shape, size and aspect ratio and filled with charged pigment particles dispersed in a dielectric solvent or solvent mixture. The electrophoretic medium additionally includes free polymers and charge control agents.

A variety of color option have become commercially available for electrophoretic displays, including four-color displays (black, white, red, yellow; red, white, yellow, semi-transparent blue; cyan, yellow, magenta, white). Electrophoretic displays with four types of electrophoretic particles operate similar to the simple black and white displays EPDs when, for example, a single color matching the color of one of the particles is desired at the viewing surface. However, obtaining a broader color gamut, including mixed colors and process colors is more complicated and requires more exquisite control of the relative positions of the particles with respect to each other and the viewing surface. When done correctly, such four particle systems allow thousands of different colors to be produced at each pixel. More details of such systems are available in the following U.S. patents, all of which are incorporated by reference in their entireties: U.S. Pat. Nos. 9,361,836, 9,921,451, 10,276,109, 10,353,266, 10,467,984, and 10,593,272.

In general, microcells of an electrophoretic display can be of any shape, and their sizes and dimensions may vary. However, there are trade-offs for every modification in shape and size. Thicker microcells are more durable and typically result in more saturated colors because more pigment is present, however thick microcells require much larger local electric fields to move the pigments into the desired position. Providing larger local electric fields typically results in more expensive electronics. In contrast, thinner electrophoretic layers can be driven with smaller electric fields, but they are less robust and manufacturing is more complex.

The microcells may be of substantially uniform size and shape in some embodiments. It is also possible to have microcells of mixed shapes and sizes. The openings of the microcells may be round, square, rectangular, hexagonal or any other shape. However, microcells with wider edge-to-edge distance of the top-openings may lead to challenges during coating, such as narrower coating window (sensitivity of electro-optic materials to variations in process controls and local ambient environment, such as temperature and humidity) and increased coating defects, including higher level of severe drop-in (SDI), i.e., when the sealant fills a portion of an individual cell resulting in a nonfunctional cell. Furthermore, as the microcell depth is reduced, coating defects (e.g., SDI) become more significant due to shortened distance between sealing to cell bottom. Thus, there remains a need for alternative microcell design that can accommodate shallower microcells and deliver desirable electric optical performances while being durable enough for incorporating into consumer electronics that are subject to a variety of external stresses, such as heat, vibration, and physical shock.

### BRIEF SUMMARY OF THE INVENTION

Disclosed herein are electrophoretic displays and methods for preparing the same.

One aspect of the invention provides an electrophoretic display comprising: a light-transmissive top electrode; an electrophoretic media layer including a film of microcells comprising partition walls and top-openings, wherein an electrophoretic fluid comprising at least four different kinds of charged pigment particles dispersed in a solvent fills the microcells, and a top-sealing layer that encloses the electrophoretic fluid within the microcells; and a backplane electrode; wherein the edge-to-edge distance of the top-opening of the microcells is in a range of 50 to 125 microns and the depth of the microcells is in a range of 3 to 15 microns.

In some embodiments, the electrophoretic fluid comprises first, second, and third kinds of subtractive pigment particles and a fourth kind of reflective pigment particles, wherein the four kinds of charged pigment particles are differently colored. In some embodiments, the electrophoretic fluid comprises first, second, and third kinds of reflective pigment particles and a fourth kind of semi-transparent pigment particles, wherein the four kinds of charged pigment particles are differently colored. In some embodiments, the edge-to-edge distance of the top-opening of the microcells is in a range of 85 to 115 microns. In some embodiments, the depth of the microcells is in a range of 5 to 10 microns. In some embodiments, the display is capable of producing seven or eight independent primary colors within five seconds, or within three seconds.

Another aspect of the invention provides a method for preparing an electrophoretic display comprising: filling an electrophoretic media layer including a film of microcells comprising partition walls and top-openings with an electrophoretic fluid comprising at least four different kinds of charged pigment particles dispersed in a solvent and sealing the electrophoretic media layer with a top-sealing layer that encloses the electrophoretic fluid within the microcells; wherein the edge-to-edge distance of the top-opening of the microcells is in a range of 50 to 125 microns and the depth of the microcells is in a range of 3 to 15 microns.

In some embodiments, the electrophoretic fluid comprises first, second, and third kinds of subtractive pigment particles and a fourth kind of reflective pigment particles, wherein the four kinds of charged pigment particles are differently colored. In some embodiments, the electrophoretic fluid comprises first, second, and third kinds of reflective pigment particles and a fourth kind of semi-transparent pigment particles, wherein the four kinds of charged pigment particles are differently colored. In some embodiments, the edge-to-edge distance of the top-opening of the microcells is in a range of 85 to 115 microns. In some embodiments, the depth of the microcells is in a range of 5 to 10 microns. In some embodiments, the display is capable of producing seven independent primary colors, and the independent primary colors are black, white, red, orange, yellow, green, and blue. In some embodiments, the display is capable of producing eight independent primary colors, and the independent primary colors are black, white, red, green, blue, magenta, yellow, and cyan.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 illustrates a structure of a plurality of microcells before they are filled and sealed.

FIG. 2 illustrates a representative cross-section of a four-particle electrophoretic display wherein the electrophoretic medium is encapsulated in microcells.

FIG. 3A illustrates the preferred position of each of the four sets of particles to produce eight standard colors in a white-cyan-magenta-yellow (WCMY) four-particle electrophoretic display, wherein the white particles are reflective and the cyan, magenta, and yellow particles are absorptive.

FIG. 3B illustrates the preferred position of each of the four sets of particles to produce seven standard colors in a white-red-yellow-blue semi-absorptive (WRYB*) four-particle electrophoretic display, wherein the white, red, and yellow particles are reflective and the blue particle is semi-absorptive (B*).

FIG. 4A illustrates an exemplary equivalent circuit of a single pixel of an electrophoretic display that uses an active matrix backplane with a storage capacitor.

FIG. 4B illustrates an exemplary equivalent circuit of a simplified electrophoretic display of the invention, allowing driving in a row-column format.

FIG. 5 illustrates an exemplary electrophoretic display that includes a display module. The electrophoretic display also includes a processor, memory, one or more power supplies, and a controller. The electrophoretic display may also include sensors to allow the electrophoretic display to adjust operational parameters based upon the ambient environment, e.g., temperature and illumination.

FIG. 6 illustrates the surface profile of the 130 μm, 115 μm, 100 μm, and 85 μm pitch microcells with 8 μm depth in an ACeP display. All microcells show bumps and the 85 μm pitch microcells have slightly higher bumps.

FIG. 7 shows the variability chart for sealing profile of the 130 μm, 115 μm, 100 μm, and 85 μm pitch microcells with 8 μm depth in an ACeP display.

FIG. 8 shows the FMT300-86 cup pitch study, specifically the coating quality analysis of the 130 μm, 115 μm, 100 μm, and 85 μm pitch microcells with 8 μm depth in an ACeP display. The microcells underwent atmospheric pressure plasma (AP) treatment prior to filling. AP (850 w/220 lpm/2 lpm): AP treatment with 850 W power, 220 liters per minute (lpm) nitrogen (N₂), and 2 lpm compressed dry air (CDA). “1” denotes visual delamination area %, “2” denotes SDI area %, “3” denotes good looking area %, and “4” denotes peeled %.

FIG. 9 shows the FMT300-89 cup pitch study, specifically the coating quality analysis of the 130 μm, 115 μm, 100 μm, and 85 μm pitch microcells with 8 μm depth in an ACeP display. The microcells underwent atmospheric pressure plasma (AP) treatment prior to filling. AP (850 w/300 lpm/2 lpm): AP treatment with 850 w power, 300 liters per minute (lpm) nitrogen (N₂), and 2 lpm compressed dry air (CDA). Increase of AP N₂ from 220 lpm (see, FIG. 8) to 300 lpm caused very small or negligible SDI (about 5% on the film edge) for the 85 μm and 100 μm microcells, but larger SDI (about 30%) for the 130 μm (control) microcells. “1” denotes visual delamination area %, “2” denotes SDI area %, “3” denotes good looking area %, and “4” denotes peeled %.

FIG. 10 shows the electric optical performance of the 130 μm and 100 μm pitch microcells with 8 μm depth in an ACeP display (experiment IDs: RS230726-33761 and RS230705-33461). FPL: front plane laminate; CR: contrast ratio; WS: white state; DS: dark sate.

FIG. 11 shows the electric optical performance of the 130 μm and 100 μm pitch microcells in an ACeP display. There are no significant differences in contrast ratio, color gamut, white state drift, or yellowing test. “1”: Color performance—0° C. CR Color85; “2”: Color performance—25° C. CR Color42, “3”: Color performance—0° C. Gamut Volume Color85; “4”: Color performance—25° C. Gamut Volume Color42; “5”: Image stability-RA t0 25° C. average drift 1-300 s; “6”: Image stability-24 hr image stability (RA DE2000 t1-t24); “7”: Yellowing-b* at run15 (200 ms test); and “8”: Yellowing-db* run1-run15 (200 ms test); “9”: FMT337 8.9 μm cups; “10”: 8 μm cups; “11”: FMT334 8.9 μm cups; “12”: batch RS230726-33752; “13”: batch RS230726-33761-2; “14”: batch RS230726-33761-4; “15”: batch RS230705-33460; “16”: batch RS230705-33461-2; “17”: batch RS230705-33461-4; “18”: 130 μm pitch microcells; “19”: 100 μm pitch microcells; “20”: CMY2.0KW×w/33% WP, MP250_H, YP363, 1.3×cmy, 0.324% coCCA633; “21”: CMY2.9KW×w/33% WP, 0.32% CCA633, MP250_H/CP/YP363 (1.2/1.08/1.2×).

FIG. 12 shows the a* vs b* overlay plots of the 130 μm and 100 μm pitch microcells in an ACeP display (experiment ID: RS230726-33761). “1”: RS230726-33761-2; “2”: RS230726-33761-4; “3”: SNAP.

FIG. 13 shows the a* vs b* overlay plots of the 130 μm and 100 μm pitch microcells in an ACeP display (experiment ID: RS230705-33461). “1”: RS230705-33461-2; “2”: RS230705-33461-4; “3”: SNAP.

FIG. 14 illustrates the surface profiles of the 130 μm, 115 μm, 100 μm, and 85 μm pitch microcells with 8 μm depth in a display including four different types of charged pigment particles. All microcells show bumps and the 85 μm pitch microcells have the highest bumps.

FIG. 15 shows the variability chart for sealing profile of the 130 μm, 115 μm, 100 μm, and 85 μm pitch microcells with 8 μm depth in a display including four different types of charged pigment particles as measured with a Zygo profilometer. Larger pitch microcells (i.e., 115 μm and 130 μm) have similar sealing profile.

FIG. 16 shows the variability chart for cloudy spot mura (CSM) or panther mura level of the 130 μm, 115 μm, 100 μm, and 85 μm pitch microcells with 8 μm depth in a display including four different types of charged pigment particles. CSM or panther mura is reduced for microcells with smaller pitch sizes.

FIG. 17 shows the FMT302-88 cup pitch study, specifically the coating quality analysis of the 130 μm, 115 μm, 100 μm, and 85 μm pitch microcells with 8 μm depth in a display including four different types of charged pigment particles. The microcells underwent atmospheric pressure plasma (AP) treatment prior to filling with 750 W power and 200 liters per minute (lpm) nitrogen (N₂). “1” denotes visual delamination area %, “2” denotes SDI area %, “3” denotes good looking area %, and “4” denotes peeled %.

FIG. 18 shows the FMT302-85 cup pitch study, specifically the coating quality analysis of the 130 μm, 115 μm, 100 μm, and 85 μm pitch microcells with 8 μm depth in a display including four different types of charged pigment particles. The microcells underwent atmospheric pressure plasma (AP) treatment prior to filling with 850 W power and 300 liters per minute (lpm) nitrogen (N₂). Increase of AP N₂ from 200 lpm to 300 lpm caused less SDI for microcells with pitch size=<100 μm. “1” denotes visual delamination area %, “2” denotes SDI area %, “3” denotes good looking area %, and “4” denotes peeled %.

FIG. 19 shows the waveforms used to drive the microcells with 8 μm and 6 μm depths, and 120 μm pitch size. (1) Three pre-measurement shakes with 500 ms+24V or −24V pulses, each pulse followed by 500 ms rest of no voltage (500 ms dwell). For example, (1A) represents a shaking pulse to mix up all the particles with 500 ms+24V pulse, (2) fourth shake with 500 ms+24V, (3) 3-second rest of no voltage (3 s dwell), (4) negative pulse for driving the display to a white state with 500 ms-24V pulse (L*, a*, and b* measured through the whole pulse and the following dwell in step (5)), (5) 3-second rest of no voltage (3 s dwell), (6) positive pulse for driving the display to a process black state with 500 ms+24V pulse (L*, a*, and b* measured through the whole pulse and the following dwell in step (7)), (7) 3-second rest of no voltage (3 s dwell), and (8) the sequence may be repeated, such as at −/+23V. A standard color optical rig was used to take continuous L*, a*, and b* values throughout the +24V pulses and rests.

FIG. 20A shows L* as a function of time for switching the microcells with 8 μm and 6 μm depths from white to black.

FIG. 20B shows the L* vs time curves fitted using a fitting program (JMP Statistical Software).

### DETAILED DESCRIPTION OF THE INVENTION

Disclosed herein are electrophoretic displays comprising microcells having edge-to-edge distances and depths that reduce coating defects and increase the operational window for filling and sealing electrophoretic fluids within the microcells. Microcells having shallow depths may suffer from more numerous and more severe coating defects than microcells having greater depths due to the reduced clearance between the top of the microcell walls and the bottom of the microcell, which means that small variations in sealing coat weight or coat speed may result in the microcells filling with sealant, a.k.a., severe drop-in. Moreover, microcells having shallower depths are more difficult to fill than microcells having greater depths, limiting the operational window for filling and sealing the microcells. Additionally, the difficulty in filling the microcells increases with high pigment loading necessary for multi-color electrophoretic displays. The present technology overcomes these challenges without diminishing the electro-optic performance, and allows for fast color switching speeds between primary colors. Fast color switching is crucial to delivering features such as web browsing and video in electrophoretic displays, i.e., epaper.

### Microcells

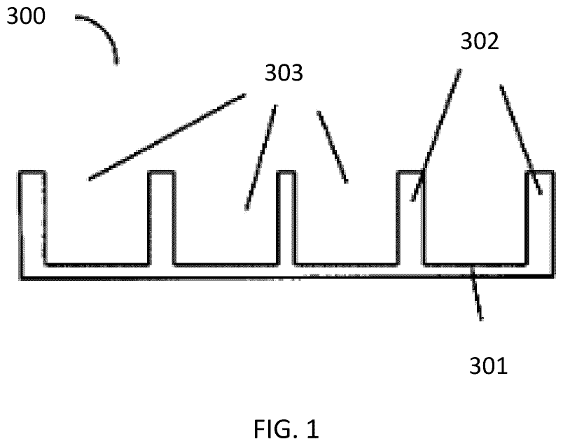

FIG. 1 illustrates a structure of a plurality of microcells 300 before they are filled and sealed. Each microcell comprises a bottom 301, walls 302, and a top opening 303.

Microcells may be formed either in a batchwise process or in a continuous roll-to-roll process as disclosed in U.S. Pat. No. 6,933,098. The latter offers a continuous, low cost, high throughput manufacturing technology for production of compartments for use in a variety of applications including benefit agent delivery and electrophoretic displays. Microcell arrays suitable for use with the invention can be created with microembossing. For example, see U.S. Pat. No. 7,715,088, which is incorporated herein by reference in its entirety.

The microcells can be of any shape, and their sizes, dimensions, and/or aspect ratio may vary. The edge-to-edge distance of the top-opening of the microcells may be less than or about equal to 125 μm, 120 μm, 115 μm, 110 μm, 105 μm, 100 μm, 95 μm, 90 μm, 85 μm, 80 μm, 75 μm, 70 μm, 65 μm, 60 μm, 50 μm, or 50 μm. For example, the edge-to-edge distance of the top-opening of the microcells may be in the range of from about 50 to about 125 μm, from about 50 to about 120 μm, from about 50 to about 115 μm, from about 50 to about 110 μm, from about 50 to about 105 μm, from about 50 to about 100 μm, from about 50 to about 95 μm, from about 50 to about 90 μm, from about 50 to about 95 μm, 60 to about 125 μm, from about 60 to about 120 μm, from about 60 to about 115 μm, from about 60 to about 110 μm, from about 60 to about 105 μm, from about 60 to about 100 μm, from about 60 to about 95 μm, from about 60 to about 90 μm, from about 60 to about 95 μm, 70 to about 125 μm, from about 70 to about 120 μm, from about 70 to about 115 μm, from about 70 to about 110 μm, from about 70 to about 105 μm, from about 70 to about 100 μm, from about 70 to about 95 μm, from about 70 to about 90 μm, or from about 70 to about 95 μm, from about 80 to about 125 μm, from about 80 to about 120 μm, from about 80 to about 115 μm, from about 80 to about 110 μm, from about 80 to about 105 μm, from about 80 to about 100 μm, from about 80 to about 95 μm, from about 80 to about 90 μm, from about 85 to about 125 μm, from about 85 to about 120 μm, from about 85 to about 115 μm, from about 85 to about 110 μm, from about 85 to about 105 μm, from about 85 to about 100 μm, or from about 85 to about 95 μm. For a hexagonal close packed design, with microcell walls of approximately 2 μm thick, the above edge-to-edge distance of the top-opening result in open areas of between 1000 μm² and 100,000 μm².

The depth of the microcells may be less than or about 15 μm, 14 μm, 13 μm, 12 μm, 11 μm, 10 μm, 9 μm, 8 μm, or 7 μm. For example, the depth of the microcells may be in the range of from about 3 to about 15 μm, from about 3 to about 14 μm, from about 3 to about 13 μm, from about 3 to about 12 μm, from about 3 to about 11 μm, from about 3 to about 10 μm, from about 3 to about 9 μm, from about 3 to about 8 μm, from about 3 to about 7 μm, from about 4 to about 15 μm, from about 4 to about 14 μm, from about 4 to about 13 μm, from about 4 to about 12 μm, from about 4 to about 11 μm, from about 4 to about 10 μm, from about 4 to about 9 μm, from about 4 to about 8 μm, from about 4 to about 7 μm, from about 5 to about 15 μm, from about 5 to about 14 μm, from about 5 to about 13 μm, from about 5 to about 12 μm, from about 5 to about 11 μm, from about 5 to about 10 μm, from about 5 to about 9 μm, from about 5 to about 8 μm, from about 5 to about 7 μm, from about 6 to about 15 μm, from about 6 to about 14 μm, from about 6 to about 13 μm, from about 6 to about 12 μm, from about 6 to about 11 μm, from about 6 to about 10 μm, from about 6 to about 9 μm, from about 6 to about 8 μm, or from about 6 to about 7 μm. For a hexagonal close packed design, with microcell walls of approximately 2 μm thick, the above depths of microcells combined with edge-to-edge distance of the top-opening result in microcell volumes of between 1000 μm³ and 1,000,000 μm³.

The term “microcell” refers to the cup-like indentations created by microembossing or imagewise exposure. The term “cell”, in the context of the present invention, is intended to mean the single unit formed from a sealed microcell. The cells are filled with charged pigment particles dispersed in a solvent or solvent mixture.

The term “well-defined”, when describing the microcells or cells, is intended to indicate that the microcell has a definite shape, size, and aspect ratio which are pre-determined according to the specific parameters of the manufacturing process.

The term “aspect ratio” is a commonly known term in the art of electrophoretic displays. In some embodiments, it may refer to the depth to width or depth to length ratio of the microcells.

### Electrophoretic Displays

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous (light-transmissive) electrode and the other electrode layer is patterned into a matrix of pixel electrodes, each of which defines one pixel of the display.

The term “light transmissive” is used in this patent and herein to mean that the layer thus designated transmits sufficient light to enable an observer, looking through that layer, to observe the change in display states of the electrophoretic medium, which will normally be viewed through the light transmissive electrode layer and adjacent substrate (if present); in cases where the electrophoretic medium displays a change in reflectivity at non-visible wavelengths, the term “light-transmissive” should of course be interpreted to refer to transmission of the relevant non-visible wavelengths.

One aspect of the present invention provides an electrophoretic display comprising a light-transmissive top electrode; an electrophoretic media layer including a film of microcells comprising partition walls and top-openings, wherein an electrophoretic fluid comprising at least four different kinds of charged pigment particles dispersed in a solvent fills the microcells, and a top-sealing layer that encloses the electrophoretic fluid within the microcells; and a backplane electrode. Microcells according to the various embodiments of the present invention may be incorporated in the electrophoretic displays and assemblies disclosed herein.

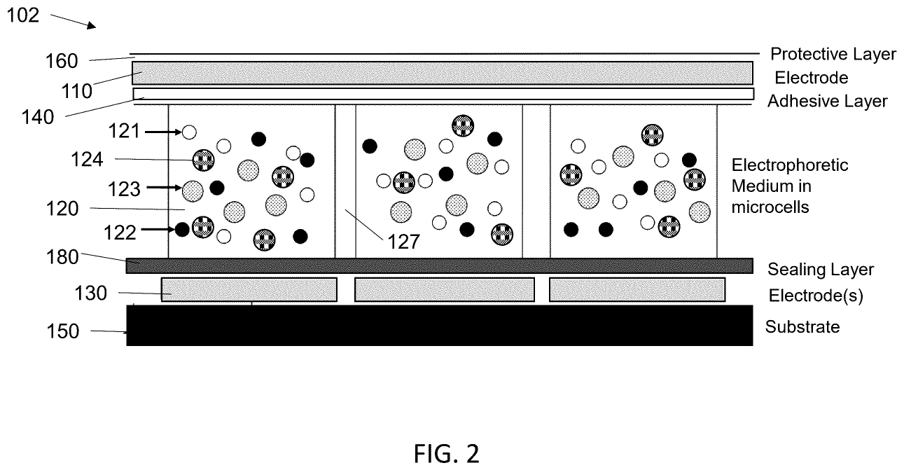

FIG. 2 illustrates an example of an electrophoretic display (102) comprising microcell structure. This example of EPD device 102 comprises a top transparent electrode 110, an electrophoretic medium 120, and a bottom electrode 130, which is often a pixel electrode of an active matrix of pixels controlled with thin film transistors (TFT). The bottom electrode 130 can be a singular larger electrode, such as a graphite backplane, a film of PET/ITO, a metalized film, or a conductive paint. In the electrophoretic media 120, there are four different types of particles, 121, 122, 123, and 124, however more than four or fewer than four particles can be used with the methods and displays described herein.

Methods for fabricating an electrophoretic display including two, three, four, or more particles have been previously disclosed. The electrophoretic fluid may be incorporated into microcell structures that are thereafter sealed with a polymeric layer. The microcell layers may be coated or laminated to a plastic substrate or film bearing a transparent coating of an electrically conductive material. The resulting assembly may be laminated to a backplane including pixel electrodes using an electrically conductive adhesive. The assembly may alternatively be attached to one or more segmented electrodes on a backplane, wherein the segmented electrodes are driven directly. In a different method of fabrication, a suspension of electrophoretic media is encapsulated in collagen, and the capsules are then coated onto a plastic substrate or film bearing a transparent coating of an electrically conductive material. In yet another embodiment of the assembly, which may include a non-planar light transmissive electrode, such capsules including electrophoretic media are spray coated onto a transparent conductive material and then overcoated with a back electrode material. (See U.S. Patent Publication No. 2021/0132459, incorporated by reference herein.).

A typical process of making sealed microcell structures for electrophoretic displays involves (a) fabricating, via microembossing, a polymeric sheet having a plurality of microcells, wherein each microcell has an opening, (b) filling the microcells with an electrophoretic medium, which is a dispersion comprising charged pigment particles in a non-polar fluid, and (c) sealing the microcells with an aqueous polymer composition, forming a sealing layer. The sealed microcells, which contain electrophoretic medium, form the electro-optic material layer of the device. The electro-optic material layer is disposed between a front and a rear electrode. Application of an electric field across the electrophoretic medium via these electrodes causes pigment particles to migrate through the electrophoretic medium creating an image. In some embodiments, the electrophoretic display may be manufactured using previously disclosed methods, such as described in U.S. Pat. Nos. 6,930,818, 8,830,561, 6,672,921 and 6,788,449, which are incorporated by reference herein.

Another aspect of the present invention provides a method for preparing an electrophoretic display. The method may comprise filling an electrophoretic media layer including a film of microcells comprising partition walls and top-openings with an electrophoretic fluid comprising at least four different kinds of charged pigment particles dispersed in a solvent; and sealing the electrophoretic media layer with a top-sealing layer that encloses the electrophoretic fluid within the microcells. Microcells according to the various embodiments of the present invention may be incorporated in the electrophoretic displays and assemblies disclosed herein.

In some embodiments, surface treatment process of the microcells such as atmospheric pressure plasma (AP) treatment is performed prior to filling the microcells. In some embodiments, dry nitrogen plasma (AP N₂) treatment is performed. The nitrogen plasma treatment may be performed at a rate of from at least 100 liters per minute (lpm), at least 200 lpm, at least 300 lpm, at least 400 lpm, at least 500 lpm, or at least 600 lpm. In some embodiments, the nitrogen plasma treatment may be performed at a rate of 220 lpm. In some embodiments, The nitrogen plasma treatment may be performed at a rate of 300 lpm. In some embodiments, different gasses or different gas mixtures, such as compressed dry air (CDA) may be used with the plasma processing.

The performance of the electrophoretic displays disclosed herein or prepared according to the methods disclosed herein may be evaluated using one or more parameters. Exemplary performance parameters of the display that may be evaluated include, without limitation, the level of image sticking or “ghosting” observed from the display, the contrast ratio (CR) of the display, the color gamut of the display the white state (WS) and/or dark state (DS) L* of the display, the resolution of the display, the image stability of the display, the amount of cloudy spot mura and/or panther mura observed, or the amount of time it takes for the display to produce one or more independent colors. In some instances, two or more of the foregoing parameters may be evaluated. (“Mura” is a generalized term for defects in the sealing layer that results in sub-optimal optical states when viewed through a microscope. Cloudy spot mura looks like evaporated water spots under the microscope while panther mura appears as streaks.)

The electrophoretic displays disclosed herein or prepared according to the methods disclosed herein may be capable of producing one or more independent colors consecutively within a short time frame. “Producing one or more independent colors” refers to generating one or more independent colors and returning to a neutral state of the display. For example, the display may be capable of producing eight independent primary colors (e.g., Red, Green, Blue, Cyan, Yellow, Magenta, White, and Black) consecutively within 10 seconds, within 8 seconds, within 5 seconds, within 3 seconds, within 2 seconds, or within 1 second at every pixel of the display. In some embodiments, the electrophoretic display is able to cycle from any first color to any second color in 350 ms or less. For example, the display may be capable of producing seven independent primary colors (e.g., Red, Green, Blue, Orange, Yellow, White, and Black) consecutively within 10 seconds, within 8 seconds, within 5 seconds, within 3 seconds, within 2 seconds, or within 1 second at every pixel of the display. In some embodiments, the electrophoretic display is able to cycle from any first color to any second color in 350 ms or less.

In some embodiments, the electrophoretic displays may display reduced levels of cloudy spot mura and/or panther mura compared to electrophoretic displays comprising microcells with alternative sizes, dimensions, and aspect ratios.

Another aspect of the invention provides a method for preparing an electrophoretic display comprising: filling an electrophoretic media layer including a film of microcells comprising partition walls and top-openings with an electrophoretic fluid comprising at least four different kinds of charged pigment particles dispersed in a solvent and sealing the electrophoretic media layer with a top-sealing layer that encloses the electrophoretic fluid within the microcells; wherein the edge-to-edge distance of the top-opening of the microcells is in a range of 50 to 125 microns and the depth of the microcells is in a range of 3 to 15 microns.

In some embodiments, the method further comprises forming the microcells comprising partition walls and top-openings, such as the microcells as described herein. For example, in some embodiments, the edge-to-edge distance of the top-opening of the microcells is in a range of 85 to 115 microns. In some embodiments, the depth of the microcells is in a range of 5 to 10 microns. In some embodiments, the depth of the microcells is in a range of 6 to 8 microns.

In some embodiments, the method comprises preparing an electrophoretic display comprising the electrophoretic media as described herein. For example, in some embodiments, the electrophoretic fluid comprises four different kinds of charged pigment particles. In some embodiments, the electrophoretic fluid comprises first, second, and third kinds of subtractive pigment particles and a fourth kind of reflective pigment particles, wherein the four kinds of charged pigment particles are differently colored. In some embodiments, the electrophoretic fluid comprises first, second, and third kinds of reflective pigment particles and a fourth kind of semi-transparent pigment particles, wherein the four kinds of charged pigment particles are differently colored. In some embodiments, the electrophoretic fluid has a total charged pigment particle loading of at least 40%. In some embodiments, the total charged pigment particle loading between 40% and 65%. In some embodiments, the top sealing layer comprises polyvinyl alcohol.

### Electrophoretic Medium

The electrophoretic medium, in the context of the present invention, refers to the composition in the microcells. Electrophoretic medium disclosed herein may comprise an electrophoretic fluid and charged particles that vary in color, reflective or absorptive properties, charge density, and mobility in an electric field (measured as a zeta potential). A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention. For example, the electrophoretic medium might include a fluid, a plurality of first and a plurality of second particles dispersed in the fluid, the first and second particles bearing charges of opposite polarity, the first particle being a light-scattering particle and the second particle having one of the subtractive primary colors, and a plurality of third and a plurality of fourth particles dispersed in the fluid, the third and fourth particles bearing charges of opposite polarity, the third and fourth particles each having a subtractive primary color different from each other and from the second particles, wherein the electric field required to separate an aggregate formed by the third and the fourth particles is greater than that required to separate an aggregate formed from any other two types of particles.

The pigment particle loading amount in the electrophoretic fluid may vary. In some embodiments, the electrophoretic fluid may have a total charged pigment particle loading of at least 20%, at least 30%, at least 35%, at least 40%, at least 45%, at least 50%, at least 60%, or at least 70%. In some embodiments, the pigment particle loading may range from about 20% to about 90%, from about 30% to about 80%, from about 40% to about 70%, from about 40% to about 65%, or from about 40% to about 60%.

The electrophoretic medium may contain two types of charged particles having different colors, a first type of charged particles having a first charge polarity, and a second type of charged particles that has a second charged polarity opposite to the first charged polarity. For example, the first type of charged particles may be black and the second type of charged particles may be white.

The electrophoretic medium may contain three types of charged particles all having different colors, a first type of charged particles having a first charge polarity, a second type of charged particles having a second charge polarity that is opposite to the first charge polarity, and a third type of charge particles having a third charge polarity that is the same as the first or the second charge polarity. For example, the first type of charged particles may be black, the second type of charged particles may be white, and the third type of charged particles may be selected from the group consisting of red, yellow, blue, cyan, magenta, green, and orange.

The electrophoretic medium may contain four types of charged particles all having different colors, a first type of charged particles having a first charge polarity, a second type of charged particles having the first charge polarity, a third type of charge particles having a second charge polarity opposite to the first charge polarity, and a fourth type of charged particles having the second charge polarity. The magnitude of the charge of the first type of particles may be higher than the magnitude of the charge of the second type of particles, and the magnitude of the charge of the third type of particles may be higher than the charge of the fourth type of particles. For example, the first type of charged particles may be cyan, the second type of charged particles may be magenta, the third type of particles may be yellow and the fourth type of charged particles may be white.

The electrophoretic medium may contain four types of charged particles all having different colors, a first type of charged particles having a first charge polarity, a second type of charged particles having the first charge polarity, a third type of charge particles having the first charge polarity, and a fourth type of charged particles having a second charge polarity that is opposite to the first charge polarity. The magnitude of the charges of the first, second, and third particles may be different from each other. The magnitude of the charge of the third type of particles may be higher than the magnitude of the charge of the first type of particles that may be higher than the magnitude of the charge of the second type of particles. For example, the first type of particles may be cyan, the second type of particles may be magenta, the third type of particles may be yellow, and the fourth type of particles may be white.

The electrophoretic medium may contain five types of charged particles all having different colors, a first type of charged particles having a first charge polarity, a second type of charged particles having the first charge polarity, a third type of particles having the first charge polarity, a fourth type of particles having a second charge polarity that is opposite to the first charge polarity, and a fifth type of particles having the second charge polarity. The magnitude of the first, second, and third charges may be different from each other. The magnitude of the charge of the third type of particles may be higher than the magnitude of the charge of the first type of particles that may be higher than the magnitude of the charge of the second type of particles. The charge of the fourth type of particles may have higher charge than the fifth type of charged particles. For one example, the first type of particles may be cyan, the second type of particles may be magenta, the third type of particles may be black, the fourth type of particles may be yellow, and the fifth type of particles may be white.

In some embodiments, the electrophoretic medium comprises an electrophoretic fluid that consists essentially of four different kinds of charged pigment particles.

In some embodiments, the present invention uses a light-scattering particle, typically white, and three substantially non-light-scattering particles. There is of course no such thing as a completely light-scattering particle or a completely non-light-scattering particle, and the minimum degree of light scattering of the light-scattering particle, and the maximum tolerable degree of light scattering tolerable in the substantially non-light-scattering particles, used in the electrophoretic of the present invention may vary somewhat depending upon factors such as the exact pigments used, their colors and the ability of the user or application to tolerate some deviation from ideal desired colors. The scattering and absorption characteristics of a pigment may be assessed by measurement of the diffuse reflectance of a sample of the pigment dispersed in an appropriate matrix or liquid against white and dark backgrounds. Results from such measurements can be interpreted according to a number of models that are well-known in the art, for example, the one-dimensional Kubelka-Munk treatment. In the present invention, it is preferred that the white pigment exhibit a diffuse reflectance at 550 nm, measured over a black background, of at least 5% when the pigment is approximately isotropically distributed at 15% by volume in a layer of thickness 1 μm comprising the pigment and a liquid of refractive index less than 1.55. The yellow, magenta and cyan pigments preferably exhibit diffuse reflectances at 650, 650 and 450 nm, respectively, measured over a black background, of less than 2.5% under the same conditions. (The wavelengths chosen above for measurement of the yellow, magenta and cyan pigments correspond to spectral regions of minimal absorption by these pigments.) Colored pigments meeting these criteria are hereinafter referred to as “non-scattering”or “substantially non-light-scattering”. Specific examples of suitable particles are disclosed in U.S. Pat. Nos. 9,921,451, which is incorporated by reference herein.

In some embodiments, alternative particle sets may also be used, including four sets of reflective particles, or one absorptive particle with three or four sets of different reflective particles, such as described in U.S. Pat. Nos. 9,922,603 and 10,032,419, which are incorporated by reference herein. For example, white particles may be formed from an inorganic pigment, such as TiO₂, ZrO₂, ZnO, Al₂O₃, Sb₂O₃, BaSO₄, PbSO₄ or the like, while black particles may be formed from CI pigment black 26 or 28 or the like (e.g., manganese ferrite black spinel or copper chromite black spinel) or carbon black. The third/fourth/fifth type of particles may be of a color such as red, green, blue, magenta, cyan or yellow. The pigments for this type of particles may include, but are not limited to, CI pigment PR 254, PR122, PR149, PG36, PG58, PG7, PB28, PB15:3, PY138, PY150, PY155 or PY20. Specific examples include Clariant Hostaperm Red D3G 70-EDS, Hostaperm Pink E-EDS, PV fast red D3G, Hostaperm red D3G 70, Hostaperm Blue B2G-EDS, Hostaperm Yellow H4G-EDS, Hostaperm Green GNX, BASF Irgazine red L 3630, Cinquasia Red L 4100 HD, and Irgazin Red L 3660 HD; Sun Chemical phthalocyanine blue, phthalocyanine green, diarylide yellow or diarylide AAOT yellow.

In FIG. 2 and similar embodiments, two of the four different types of particle sets, 121, 122, 123, and 124 are of first polarity, while the other two sets are of a second (opposite) polarity. In some embodiments, one of the four different types of particle sets, 121, 122, 123, and 124 is of first polarity, while the other three sets are of a second (opposite) polarity. In some embodiments two of the four different types of particle sets are of a first polarity, while the other two sets are of an opposite polarity. The electrophoretic medium 120 is typically compartmentalized by a the walls of a microcell 127. An optional adhesive layer 140 can be disposed adjacent any of the layers, however, it is typically adjacent an electrode layer (110 or 130). There may be more than one adhesive layer 140 in a given electrophoretic display (105, 106), however only one layer is more common. The entire display stack is typically disposed on a substrate 150, which may be rigid or flexible. The display 102 typically also includes a protective layer 160, which may simply protect the top electrode 110 from damage, or it may envelop the entire display 102 to prevent ingress of water, etc. Electrophoretic displays 102 may also include sealing layers 180 as needed. In some embodiments the adhesive layer 140 may include a primer component to improve adhesion to the electrode layer 110, or a separate primer layer (not shown in FIG. 2) may be used. The structures of electrophoretic displays and the component parts, pigments, adhesives, electrode materials, etc., are described in many patents and patent applications published by E Ink Corporation, such as U.S. Pat. Nos. 6,922,276; 7,002,728; 7,072,095; 7,116,318; 7,715,088; and 7,839,564, all of which are incorporated by reference herein in their entireties.

Additionally, the charged pigment particles may be functionalized with surface polymers to improve state stability. Such pigments are described in U.S. Pat. No. 9,921,451, which is incorporated by reference in its entirety.

The electrophoretic medium of the present invention may contain any of the additives used in prior art electrophoretic media as described for example in patents and applications mentioned above. Thus, for example, the electrophoretic medium of the present invention may comprise at least one charge control agent to control the charge on the various particles, and the fluid may have dissolved or dispersed therein a polymer having a number average molecular weight in excess of about 20,000 and being essentially non-absorbing on the particles to improves the bistability of the display, as described in the aforementioned U.S. Pat. No. 7,170,670.

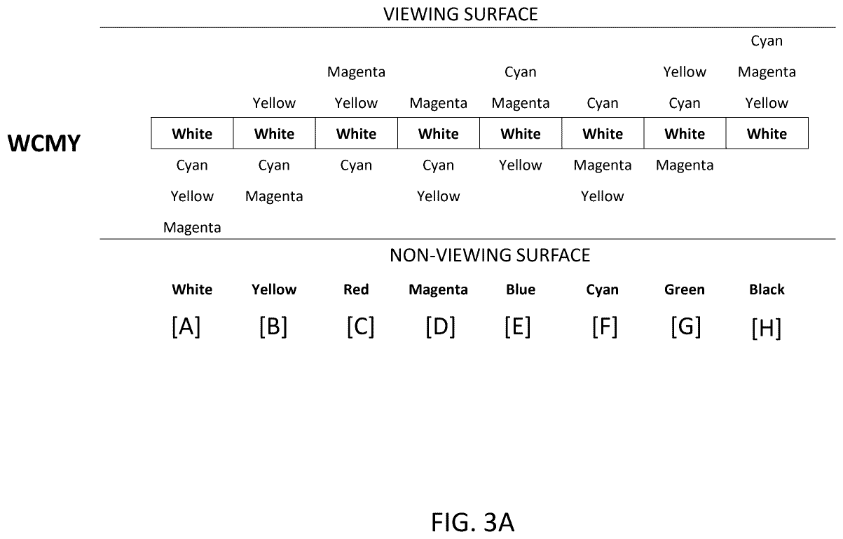

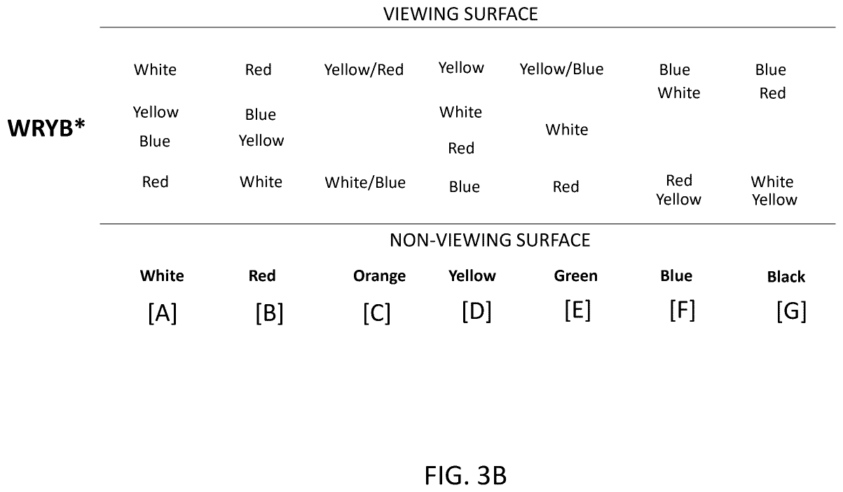

A color electrophoretic display may include a color filter array or an expanded particle system capable of producing all colors above each pixel electrode. As shown in FIG. 3A, in the instance of a four-particle system including subtractive cyan, yellow, and magenta particles paired with a reflective white particle, each of the eight principal colors (red, green, blue, cyan magenta, yellow, black and white) corresponds to a different arrangement of the four pigments. The three particles providing the three subtractive primary colors, e.g., for an Advanced Color electronic Paper (ACeP) display, may be substantially non-light-scattering (“SNLS”). The use of SNLS particles allows mixing of colors and provides for more color outcomes than can be achieved with the same number of scattering particles. These thresholds must be sufficiently separated relative to the voltage driving levels for avoidance of cross-talk between particles, and this separation necessitates the use of high addressing voltages for some colors. In addition, addressing the colored particle with the highest threshold also moves all the other colored particles, and these other particles must subsequently be switched to their desired positions at lower voltages.

The system of FIG. 3A, in principle, works similar to printing on bright white paper in that the viewer only sees those colored pigments that are on the viewing side of the white pigment (i.e., the only pigment that scatters light). In FIG. 3A, it is assumed that the viewing surface of the display is at the top (as illustrated), i.e., a user views the display from this direction, and light is incident from this direction. As already noted, in preferred embodiments only one of the four particles used in the electrophoretic medium of the present invention substantially scatters light, and in FIG. 3A this particle is assumed to be the white pigment. This light-scattering white particle forms a white reflector against which any particles above the white particles (as illustrated in FIG. 3A) are viewed. Light entering the viewing surface of the display passes through these particles, is reflected from the white particles, passes back through these particles and emerges from the display. Thus, the particles above the white particles may absorb various colors and the color appearing to the user is that resulting from the combination of particles above the white particles. Any particles disposed below (behind from the user's point of view) the white particles are masked by the white particles and do not affect the color displayed. Because the second, third and fourth particles are substantially non-light-scattering, their order or arrangement relative to each other is unimportant, but for reasons already stated, their order or arrangement with respect to the white (light-scattering) particles is critical.

More specifically, when the cyan, magenta and yellow particles lie below the white particles (Situation [A] in FIG. 3A), there are no particles above the white particles and the pixel simply displays a white color. When a single particle is above the white particles, the color of that single particle is displayed, yellow, magenta and cyan in Situations [B], [D] and [F] respectively in FIG. 3A. When two particles lie above the white particles, the color displayed is a combination of those of these two particles; in FIG. 3A, in Situation [C], magenta and yellow particles display a red color, in Situation [E], cyan and magenta particles display a blue color, and in Situation [G], yellow and cyan particles display a green color. Finally, when all three colored particles lie above the white particles (Situation [H] in FIG. 3A), all the incoming light is absorbed by the three subtractive primary colored particles and the pixel displays a black color. Because the order of the particles between the pixel electrode and viewer is critical, a pixel electrode that is not updated during a partial update can be disturbed by a neighboring pixel that is being updated. Furthermore, the resulting color shift may not be predictable because the highest charged particles, typically cyan, move the most due to inter-pixel coupling.

As applied to the particle set illustrated in FIG. 3A, producing eight independent primary colors refers to switching between white, yellow, red, magenta, blue, cyan, green, and black (Situations [A]-[H], respectively). The independent primary colors may be switched in any order. The time to produce all eight independent primary colors may be determined by detecting each of the eight independent primary colors or by detecting two (e.g., white and black) or more independent primary colors and approximating the time two switch between each of the eight independent primary colors.

An alternative particle set using reflective color particles is shown in FIG. 3B. In the embodiment of FIG. 3B, the reflective particles are white, red, and yellow, and they are combined with a semi-transparent blue. However, alternative color sets could be used provided that the combination of colors suitably spanned the useful color spectrum. In the system of FIG. 3B, for white, red, and yellow, the color viewed at the surface is due to direct reflection of the colored particles, for orange it is a mixture of red and yellow reflective pigments. For green, blue, and black at the viewing surface, the colors at the viewing surface are due to mixtures of the semi-transparent blue particle with reflective yellow, white, and red particles, respectively. Because a viewer is looking at light that is predominantly only interacting with one pigment surface, images produced with a system of FIG. 3B appear more saturated than the colors of FIG. 3A. However, the overall gamut of colors using a system of FIG. 3B is diminished as compared to those of FIG. 3A because it is difficult to achieve fine control of the amount of specific particles that are mixed together to create secondary colors (e.g., orange, green, violet). In applications such as digital signage, the saturation is often more important than the color gamut, and many users are satisfied with a set of seven or eight “standard” colors. It should also be realized with respect to FIG. 3B, that the reflective red and semi-transparent blue particles can switch roles, i.e., to make an electrophoretic display medium including reflective white, yellow, and blue particles and a semi-transparent red particle. Such a system yields a set of primary colors similar to FIG. 3B, but wherein red at the viewing surface results from a combination of semi-transparent red and white. Because the system of FIG. 3B includes mostly reflective particles, electrophoretic displays including this medium are less influenced by inter-pixel coupling.

As applied to the particle set illustrated in FIG. 3B, producing seven independent primary colors refers to switching between white, red, orange, yellow, green, blue, and black (Situations [A]-[G], respectively). The independent primary colors may be switched in any order. The time to produce all seven independent primary colors may be determined by detecting each of the seven independent primary colors or by detecting two (e.g., white and black) or more independent primary colors and approximating the time two switch between each of the seven independent primary colors.

Different combinations of light scattering and light absorbing particle sets are also possible. For example, one subtractive primary color could be rendered by a particle that scatters light, so that the display would comprise two types of light-scattering particle, one of which would be white and another colored. In this case, however, the position of the light-scattering colored particle with respect to the other colored particles overlying the white particle would be important. For example, in rendering the color black (when all three colored particles lie over the white particles) the scattering colored particle cannot lie over the non-scattering colored particles (otherwise they will be partially or completely hidden behind the scattering particle and the color rendered will be that of the scattering colored particle, not black). Of course, it would not be easy to render the color black if more than one type of colored particle scattered light without the presence of an absorptive black particle.

FIGS. 3A and 3B show idealized situations in which the colors are uncontaminated (i.e., the light-scattering white particles completely mask any particles lying behind the white particles in FIG. 3A, or the selected reflective particles shield all of the other particles that should not be visible in FIG. 3B). In practice, the masking by the white particles may be imperfect so that there may be some small absorption of light by a particle that ideally would be completely masked. Such contamination typically reduces both the lightness and the chroma of the color being rendered. In the instance of FIG. 3B, the presence of the light-absorbing particles often causes the overall image to look darker due to imperfect scattering of the reflective particles. This is particularly problematic for green hues because the human eye is very sensitive to different shades of green, whereas different shades of red are not as noticeable. In some embodiments, this can be corrected with the inclusion of additional particles with different steric or charge characteristics, e.g., a green scattering particle, however adding additional particles complicates the drive scheme and may require a wider range of driving voltages. In the electrophoretic media described herein, such color contamination should be minimized to the point that the colors formed are commensurate with an industry standard for color rendition. A particularly favored standard is SNAP (the standard for newspaper advertising production), which specifies L*, a* and b* values for each of the eight primary colors referred to above.

### Sealing Layer

The sealing layer plays an important role for the function and performance of the device. Firstly, as the sealing layer is in contact with the electrophoretic medium and seals it inside the microcavities, (1) it must be practically insoluble in the non-polar fluid of the electrophoretic medium and (2) it must be a good barrier to the non-polar fluid, so that the non-polar fluid does not diffuse or leak out form the microcells during the life of the device. Secondly, the sealing layer must not absorb significant amount of moisture from the environment. That is, it must prevent environmental moisture from entering into the electrophoretic medium of the device; such moisture would negatively affect the electro-optic performance of the device. Finally, it is important that the sealing layer of an electrophoretic display has good electrical properties, such as electrical volume resistivity. The electric field, which is applied across the electrophoretic medium for the operation of the display, is transmitted through the sealing layer.

The sealing of the filled microcells may be accomplished in a number of ways. One approach involves the mixing of the aqueous polymer composition with the electrophoretic medium composition. The aqueous polymer composition may be immiscible with the electrophoretic medium composition, preferably having a specific gravity lower than that of the electrophoretic medium composition. The two compositions, the aqueous polymer composition and the electrophoretic medium composition, are thoroughly mixed and immediately coated onto the plurality of microcells with a precision coating mechanism such as Meyer bar, gravure, doctor blade, slot coating or slit coating. Excess fluid is scraped away by a wiper blade or a similar device. A small amount of a weak solvent or solvent mixture such as isopropanol, methanol or an aqueous solution thereof may be used to clean the residual fluid on the top surface of the partition walls of the microcells. The aqueous polymer composition is subsequently separated from the electrophoretic medium composition and floats on top of the electrophoretic medium composition.

In a second approach, which is more common for mass-production, the electrophoretic medium composition may be filled into the microcells first and an aqueous polymer composition is subsequently overcoated onto the filled microcells as a second step. The overcoating may be accomplished by a conventional coating and printing process, such as slot die, blanket coating, inkjet printing or other printing processes. A sealing layer, in this approach, is formed in situ, by hardening the aqueous polymer composition by solvent evaporation, radiation, heat, moisture, or an interfacial reaction. Interfacial polymerization followed by UV curing is beneficial to the sealing process. Intermixing between the electrophoretic medium composition and the sealing overcoat is significantly suppressed by the formation of a thin barrier layer at the interface by interfacial polymerization. The sealing is then completed by a post curing step, for example, by UV radiation. The degree of intermixing may be further reduced when the specific gravity of the aqueous polymer composition is lower than that of the electrophoretic medium composition. Volatile organic solvents may be used to adjust the viscosity and thickness of the sealing overcoat. Rheology of the aqueous polymer composition may be adjusted for optimal sealability and coatability. When a volatile solvent is used in the overcoat, it is preferred that it is immiscible with the solvent in the electrophoretic medium composition.

In some embodiments, the top sealing layer of the electrophoretic display comprises polyvinyl alcohol.

Coating defects may arise during sealing, such as delamination, and/or cracking of the sealing layer; severe drop-in (SDI), or visual imperfections such as mura. The electrophoretic displays disclosed herein or prepared according to the methods disclosed herein may display fewer coating defects during the sealing of the microcells.

“Severe drop-in (SDI)” refers to the presence of the sealing layer in the microcell, which displaces the engineered pigment particles in the dispersion and causes severe defects in electric optical performance of the electrophoretic display. It is quantified by observing a field of filled and sealed microcells under a microscope and counting a % of individual microcells that are not switching as compared to the number of individual microcells that are visible in the microscope optical field. In some embodiments, the total SDI area is less than 30% of the total sealed microcell area. In some embodiments, the total SDI area is less than 25% of the total sealed microcell area. In some embodiments, the total SDI area is less than 20% of the total sealed microcell area. In some embodiments, the total SDI area is less than 15% of the total sealed microcell area. In some embodiments, the total SDI area is less than 10% of the total sealed microcell area. In some embodiments, the total SDI area is less than 5% of the total sealed microcell area.

In some embodiments, sealing of the microcells result in at least 70%, at least 80%, at least 90%, or 100% adhesion of the sealing layer to the electrophoretic media layer.

The coating quality of the microcells may be assessed quantitatively and/or qualitatively. Qualitative analysis may be conducted visually or spectroscopically. In some embodiments, coating quality may be assessed visually or spectroscopically to identify the amount of bumps in the microcells and/or the coating defects, such as SDI, delamination areas, peeled areas, and/or cracked areas. In some embodiments, coating quality may be assessed quantitatively through a surface profile to identify the total SDI area. In some embodiments, coating quality may be assessed quantitatively through a peeling test to identify % adhesion or % peeled of the sealing layer.

The term “coating window” refers to the range of one or more parameters within which acceptable coating quality recognized by one of ordinary skill in the art can be achieved. In some embodiments, coating window may refer to the range of AP dosage within which acceptable coating quality of the microcells can be achieved. In some embodiments, “coating window” may refer to a sensitivity of the process to local ambient conditions, such as temperature and humidity. In some embodiments, “coating window” may refer to sensitivity of the process to manufacturing variables such as web speed, web tension, coating edge angle, viscosity, etc.

In some embodiments, the sealing layer may comprise previously disclosed composition, such as described in U.S. Patent Publication No. 2022/0244612, and 2023/0159785, which are incorporated by reference herein. For example, the sealing layer may comprise a water soluble poly(vinyl alcohol) homopolymer or poly(vinyl alcohol-co-ethylene) copolymer.

### Driving the Device

For the most part, electrophoretic media, such as described above, are designed to be driven with low voltage square waves, such as produced by a driver circuit using a thin-film-transistor backplane. Such driver circuits can be inexpensively mass-produced because they are very closely related to the driving circuitry and fabrication methods that are used to produce liquid crystal display panels, such as found in smart phones, laptop monitors, and televisions. Historically, even when electrophoretic media are driven directly via an isolated electrode (e.g., segmented electrode) the driving pulses are delivered as square waves, having an amplitude and a time width. See, for example, U.S. Pat. No. 7,012,600, incorporated by reference in its entirety. Typically, for an active matrix backplane including an array of pixel electrodes, each pixel electrode will receive a signal pulse (square wave) for a short period of time as the array of pixel electrodes are addressed in a line-by-line fashion. The period of time that it takes to update the entire array of pixels, and also the time between updates of an individual pixel electrode is known as a frame. The collection of voltage impulses required to change the display from a first display state to a second state is generally known as a waveform. A waveform typically includes at least three frames, e.g., as described in U.S. Pat. No. 11,620,959, which is incorporated by reference in its entirety.

Electro-optic displays typically have a backplane provided with a plurality of pixel electrodes each of which defines one pixel of the display. Each pixel electrode is typically disposed in a rectangular array of pixel electrodes and each pixel electrode is controlled with a thin-film transistor (TFT), and the TFTs are updated in a row-by-row fashion. Conventionally, a single common electrode extends over a large number of pixels, and normally the whole display is provided on the opposed side of the electro-optic medium. The single common electrode is coupled to the backplane via an isolated electrical connection, a.k.a., a “top plane connection.” The individual pixel electrodes may be driven directly (i.e., a separate conductor may be provided to each pixel electrode) or the pixel electrodes may be driven in an active matrix manner which will be familiar to those skilled in backplane technology. Since adjacent pixel electrodes will often be at different voltages, they must be separated by inter-pixel gaps of finite width in order to avoid electrical shorting between electrodes. Although at first glance it might appear that the electro-optic medium overlying these gaps would not switch when drive voltages are applied to the pixel electrodes (and indeed, this is often the case with some non-bistable electro-optic media, such as liquid crystals, where a black mask is typically provided to hide these non-switching gaps), in the case of many bistable electro-optic media the medium overlying the gap does switch because of a phenomenon known as “blooming”.

Blooming refers to the tendency for application of a drive voltage to a pixel electrode to cause a change in the optical state of the electro-optic medium over an area larger than the physical size of the pixel electrode. An area of blooming is not a uniform color, but is typically a transition zone where, as one moves across the area of blooming, the color of the medium transitions from the desired color to another shade or color, for example a desired white pixel may include various shades of gray along the edges, a.k.a., “edge ghosting”. Furthermore, depending upon the type of display, i.e., black/white, color, black/white with color filter, the results of the edge ghosting can range from annoying to debilitating. In some cases, asymmetric blooming may contribute to edge ghosting.

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays. While the bistable nature of electrophoretic displays allows for massive power savings over traditional “always on” displays such as LCD and LED, the bistability can lead to image retention between updates, e.g., “ghosts”.

The term impulse, when used to refer to driving an electrophoretic display, is used herein to refer to the integral of the applied voltage with respect to time during the period in which the display is driven. The term waveform, when used to refer to driving an electrophoretic display is used to describe a series or pattern of voltages provided to an electrophoretic medium over a given time period (seconds, frames, etc.) to produce a desired optical effect in the electrophoretic medium.

Waveforms for driving four-particle electrophoretic media have been described previously. Waveforms for driving color electrophoretic displays having four particles are described in U.S. Pat. Nos. 9,921,451, 9,812,073, and 11,640,803, all of which are incorporated by reference herein. Most commercial electrophoretic displays use amorphous silicon based thin-film transistors (TFTs) in the construction of active matrix backplanes (260) because of the wider availability of fabrication facilities and the costs of the various starting materials. Amorphous silicon thin-film transistors may become unstable when supplied gate voltages that would allow switching of voltages higher than about +/−15V, e.g., +/−24V. Accordingly, as described in previous patents/applications on such systems, improved performance is achieved by additionally changing the bias of the top light-transmissive electrode with respect to the bias on the backplane pixel electrodes, a technique known as top-plane switching. Thus, if a voltage of +30V (relative to the backplane) is needed, the top plane may be switched to −15V while the appropriate backplane pixel is switched to +15V. Methods for driving a four-particle electrophoretic system with top-plane switching are described in greater detail in, for example, U.S. Pat. No. 9,921,451. In alternative embodiments, metal oxide semiconductors may be incorporated into thin film transistors for active matrix backplanes (260), including IGZO, i.e., as described in U.S. Pat. No. 11,776,496, which is incorporated by reference in its entirety.

In some embodiments, the electrophoretic display may include only a first light-transmissive electrode, an electrophoretic medium, and a second (rear) electrode, which may also be light-transmissive. However, to produce a high-resolution display, e.g., as shown in FIG. 2, each pixel must be addressable without interference from adjacent pixels so that an image file is faithfully reproduced in the display. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode which is conventionally provided on the opposed side of the electro-optic medium from the non-linear array and extends across the whole display.)

After a pre-selected interval known as the “line address time” the selected row is deselected, the next row is selected, and the voltages on the column drivers are changed so that the next line of the display is written. This process is repeated so that the entire display is written in a row-by-row manner. The entire process is coordinated with a clock circuit. The time between addressing a pixel for the nth time and the following addressing, n+1, is known as a “frame.” Thus, a display that is updated at 60 Hz has frames that are 16 msec. “Frames” are not limited to use with an active matrix backplane, however. The driving frames described herein can also be used to refer to a unit of time between updates of, e.g., a singular backplane. While it is possible to drive electrophoretic media with an analog voltage signal, such as produced by a power supply and a potentiometer, the use of a digital controller discretizes the waveform into blocks that are typically on the order of 10 ms, however shorter or longer framewidths are possible.

In a conventional electrophoretic display using an active matrix backplane, each pixel electrode has associated therewith a capacitor electrode (storage capacitor) such that the pixel electrode and the capacitor electrode form a capacitor; see, for example, International Patent Publication WO 01/07961. In some embodiments, N-type semiconductor (e.g., amorphous silicon) may be used to from the transistors and the “select” and “non-select” voltages applied to the gate electrodes can be positive and negative, respectively.

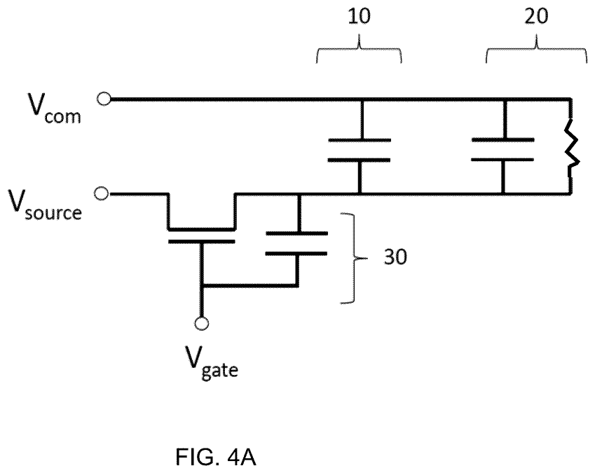

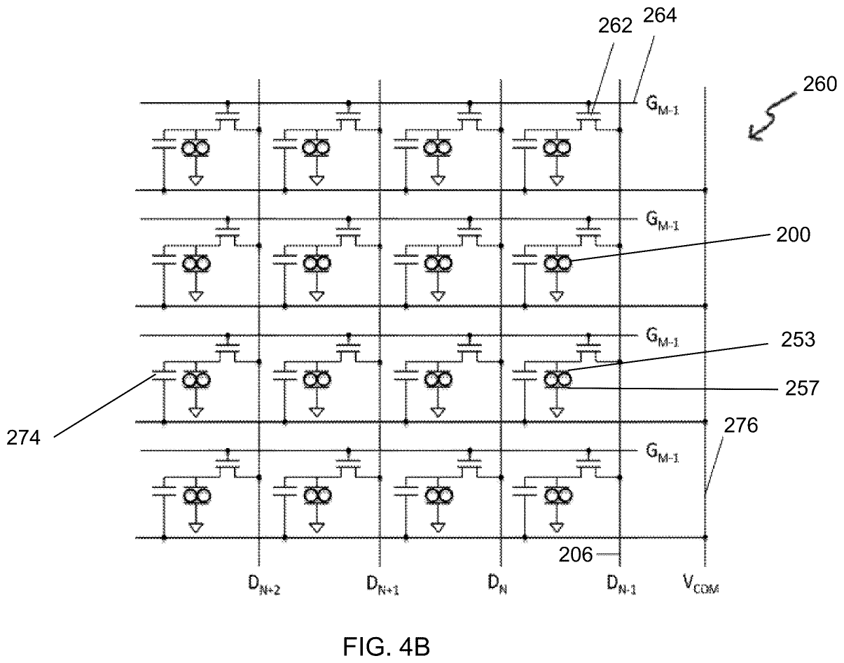

FIG. 4A depicts an exemplary equivalent circuit of a single pixel of an electrophoretic display. As illustrated, the circuit includes a capacitor 10 formed between a pixel electrode and a capacitor electrode. The electrophoretic medium 20 is represented as a capacitor and a resistor in parallel. In some instances, direct or indirect coupling capacitance 30 between the gate electrode of the transistor associated with the pixel and the pixel electrode (usually referred to a as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts.

In some embodiments, the TFT array forms an active matrix 260 for image driving, as shown in FIG. 4B. For example, each pixel electrode 253 (corresponding to 130 in FIG. 2) is coupled to a thin-film transistor 262 patterned into an array, and connected to gate (row) driver lines 264 and source (column) driver lines 206, running at right angles to the gate drive lines 264. Also, typically, the common (top) light-transparent electrode 257 (corresponding to 110 in FIG. 2) has the form of a single continuous electrode while the other electrode or electrode layer is patterned into a matrix of pixel electrodes 253, each of which defines one pixel of the display. Between the pixel electrode 253 and the common electrode 257, an electrophoretic medium 200 can be disposed. Any of the electrophoretic media described above may be used, and while FIG. 4B depicts the electrophoretic medium as contained in microcapsules, microcells, as shown in FIG. 2, are also suitable. A source driver (not shown) is connected to the source driver lines 206 and provides source voltage to all TFTs 262 in a column that are to be addressed. A gate driver (not shown) is connected to the gate driver lines 264 to provide a bias voltage that will open (or close) the gates of each TFT 262 along the row. Each pixel of the active matrix 260 also includes a storage capacitor 274 as discussed above with respect to FIG. 4A. The storage capacitors 274 may be coupled to a common potential (V_{com}) line 276. In some embodiments the common light-transparent electrode 257 is coupled to ground, as shown in FIG. 4B. In some embodiments, the common light-transparent electrode 257 is also coupled to V_{com} line 276 (not shown in FIG. 4B).

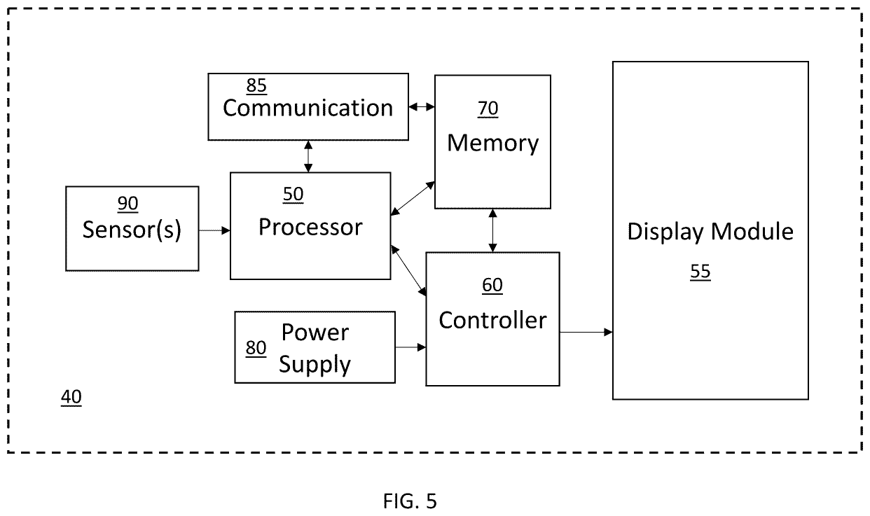

The active matrix 260 described with respect to FIG. 4B (i.e., including the electrophoretic medium 200 and the common light-transparent electrode 257) is typically covered by a protective sheet (e.g., integrated barrier) and sealed to create a display module 55, as shown in FIG. 5. Such a display module 55 becomes the focus of an electrophoretic display 40. The electrophoretic display 40 will typically include a processor 50, which is configured to coordinate the many functions relating to displaying content on the display module 55, and to transform “standard” images, such as sRGB images to a color regime that best duplicates the image on the display module 55. In some embodiments, the processor 50 performs the methods of the invention by determining which pixel electrodes should be updated during a partial update. Especially when dithering is being used for color production, the processor 50 can determine which areas of the dithered color are most at risk from blooming due to nearby pixel electrode updates. In other embodiments, some or all of the steps of the invention may be completed by the controller 60. As controller 60 architecture advances, more of the image processing can be embedded into the controller 60 such that an advanced controller can be incorporated into the same package as the display module 55 and pre-programmed with the tools needed to identify pixel electrodes that are at risk of blooming during a partial update. Advanced controllers for electrophoretic displays are available from ULTRACHIP and NEXTRONIX.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

The Examples demonstrate that microcells with a pitch-size (i.e., edge-to-edge distance of the top-opening of the microcells) less than 130 micron significantly reduced SDI and widened the coating window (i.e., making the process less sensitive to various process conditions) without sacrificing fill factor and electro-optic (EO) performance. Moreover, microcells with a pitch-size less than 130 micron reduce the amount of internal phase scooped out of the microcells due to pressure applied through a filing rod or blade during the filling process. The Examples include comparative data for 130 micron, 115 micron, 100 micron, and 85 micron pitch microcells. Microcells with the four different pitch sizes were embossed on the same panel with four quarter sections.

Overall, the coating data showed smaller-pitch microcells have much less or no SDI, improved cloudy spot mura, and/or improved panther mura compared with the control microcells. The coating window is greatly improved because of less SDI and/or desired adhesion of sealing to microcells achievable with higher AP dosage. The reduced microcell pitch size also makes coating of shallow cells (e.g., <=8 μm) more feasible.

In addition, the Examples demonstrate that microcells with shallower depths can achieve faster color-switching speed. This allows the electrophoretic display to produce eight primary colors consecutively within a short timeframe (e.g., <=3 sec).

### Example 1

ACeP panels were prepared having a depth of 8 micron and pitch-size of 130, 115, 100, or 85 micron. An ACeP display comprises the pigment particle set as shown in FIG. 3A. The microcell films were created by embossing an acrylate thin film disposed on a PET-ITO backing (Saint Gobain). See U.S. Pat. Nos. 6,930,818 and 8,830,561. The embossed microcell film was exposed to atmospheric pressure plasma treatment to improve adhesion of the sealing layer. An electrophoretic medium suspension including white, cyan, yellow, and magenta particles was subsequently coated over the treated microcells with a doctor blade and the excess electrophoretic medium was removed from the microcell film surface. The filled microcells were then coated with a sealing layer including poly(vinyl alcohol-co-ethylene) copolymer and dispersed carbon black. The filled and sealed film was then baked in an online oven and evaluated. The profiles of the sealed microcells were evaluated with a Zygo profilometer, they were inspected visually through a microscope to score for severe drop-in (SDI), and the final filled and sealed films were coupled to active matrix backplanes and evaluated for electro-optical performance. See Hertel and Penczek, Information Display, 36, p. 14-44 (2020).

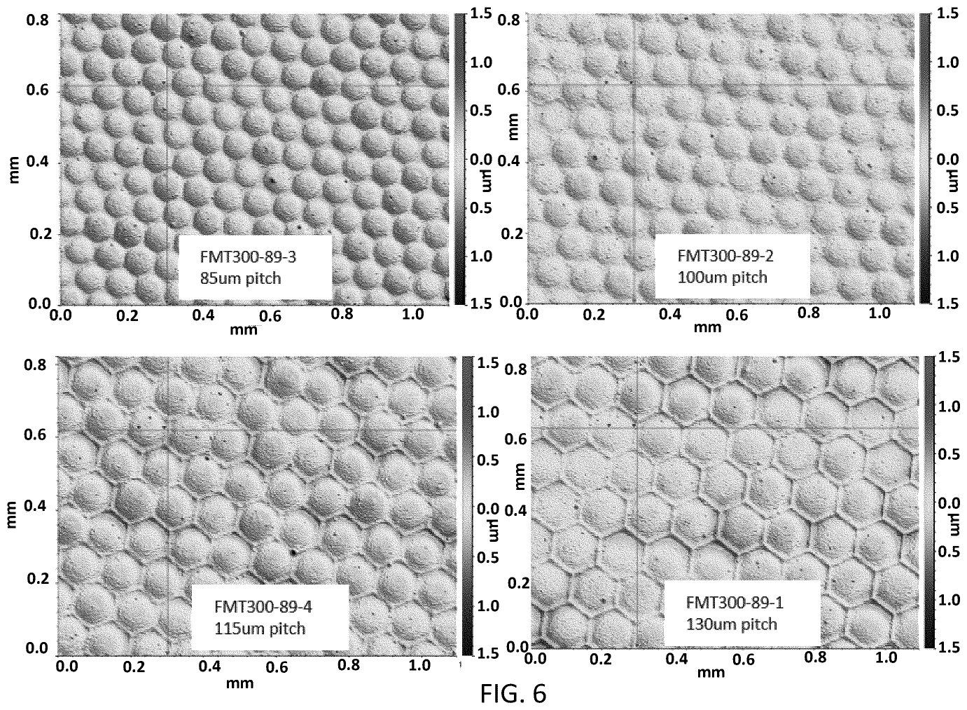

FIG. 6 shows a Zygo surface profile for the different pitch-sizes tested. All of the microcells showed bumps indicating that IP was sealed within the microcells. The microcells with the smallest pitch-size, i.e., 85 micron, had the highest bumps, indicating little to no drop-in.

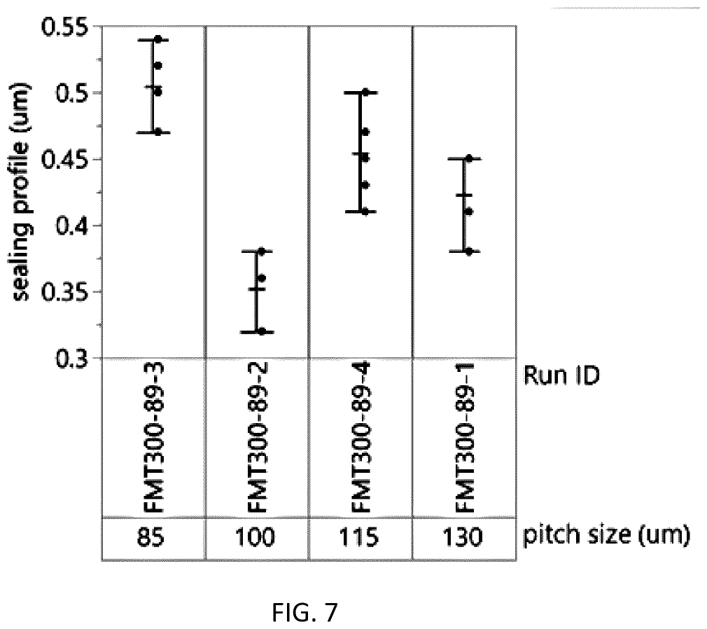

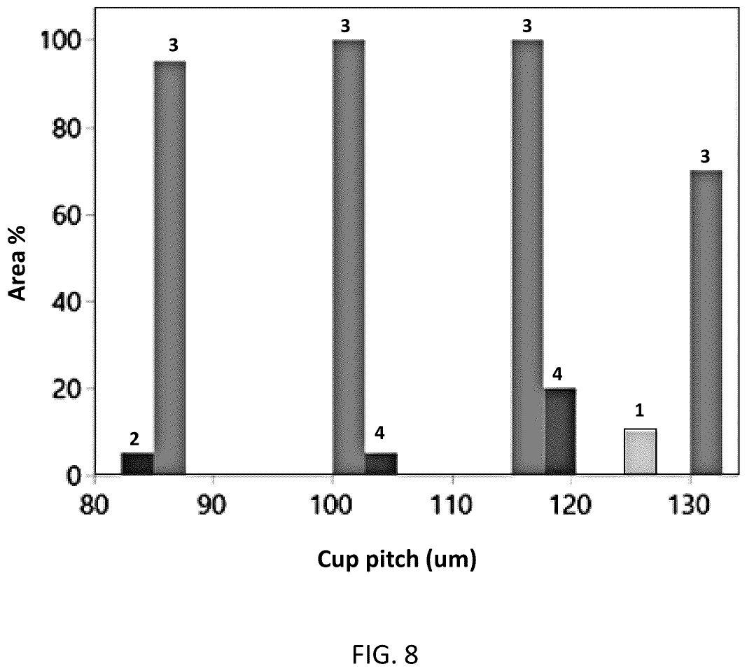

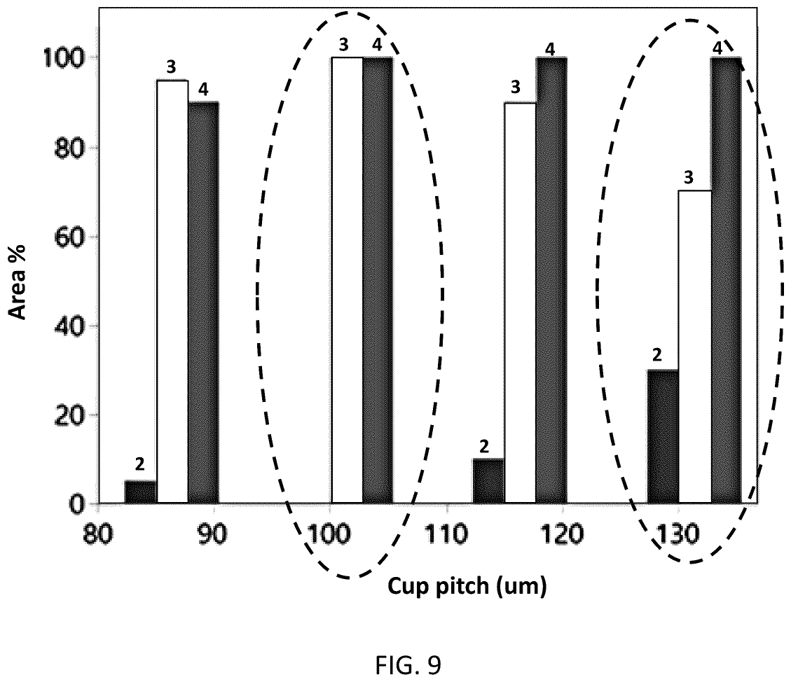

FIG. 7 shows the variability in sealing profile based upon the Zygo profiles of FIG. 6. FIGS. 8 and 9 compare the amount of SDI for the microcells prepared with different atmospheric pressure (AP) plasma treatments. When the microcells were prepared with 220 lpm of nitrogen minimal SDI was observed for each of the four different microcells, however the peeled % data suggests that overall, the sealing layer was not affixing to the tops of the microcell walls, resulting in few of the microcells being pulled from the PET-ITO backing when the sealing layer was removed with tape. However, when the microcells were prepared with 300 lpm of nitrogen some SDI was observed with the larger microcells, however the overall adhesion seemed better as evidenced by the peeled %. Notably, the smaller-pitch microcells showed a wider AP coating window and better overall coating quality, as well as less SDI.

### Example 2

ACeP panels having a depth of 8 micron and pitch-size of 130 or 100 micron were tested for EO performance using an optical rig as described in Hertel and Penczek.

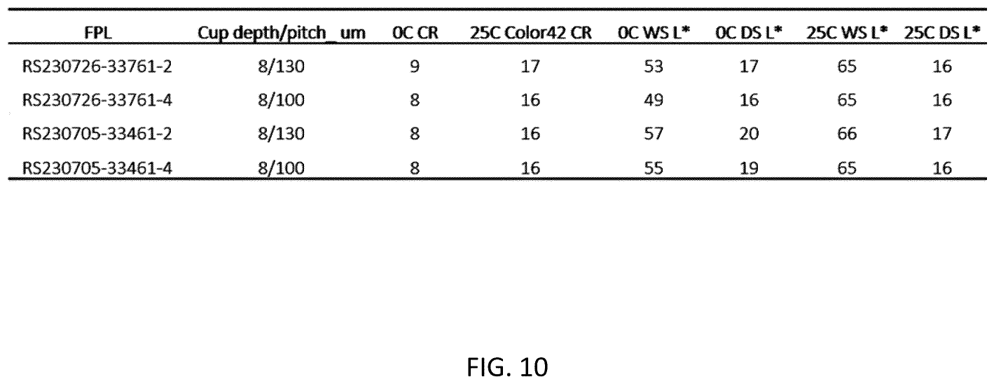

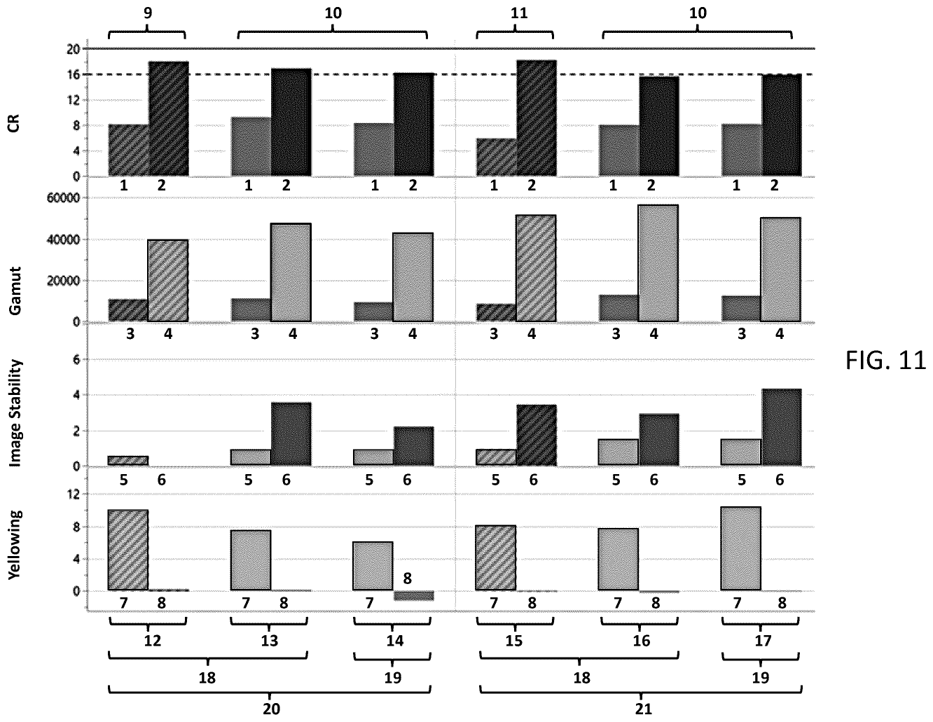

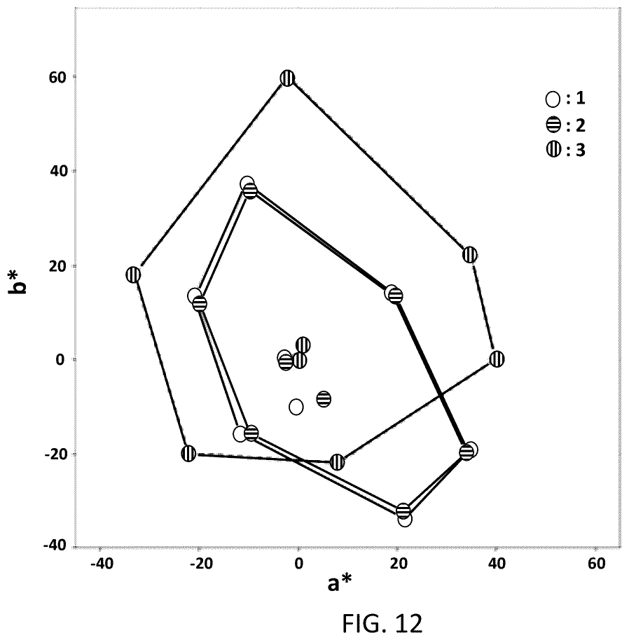

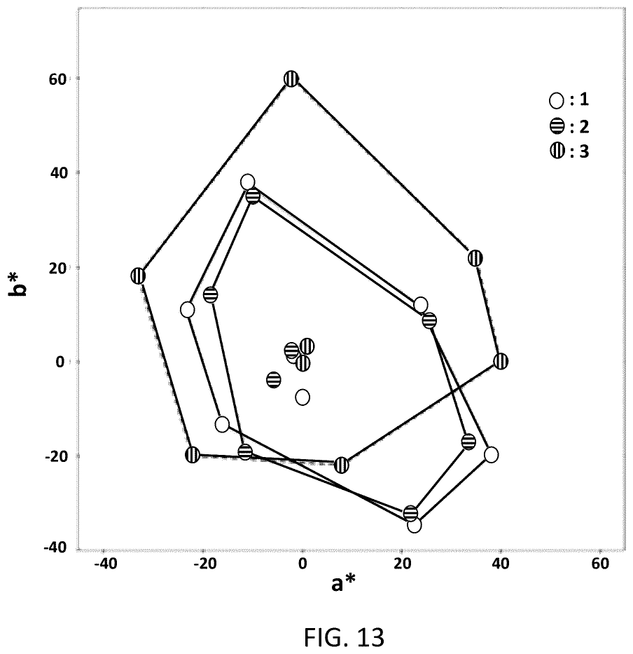

FIGS. 10-13 indicate that EO performance was not compromised for the 100 μm-pitch microcells when comparing microcells with 100 μm and 130 μm pitch sizes. Specifically, there were no significant differences in contrast ratio, color gamut, white state drift, or yellowing test result. The various samples were using identical driving waveforms on identical active matrix backplanes.

### Example 3

An alternative electrophoretic media including four different types of charged pigment particles that are all reflective (see FIG. 3B) were filled and sealed into a microcell film having a depth of 8 micron and pitch-size of 130, 115, 100, or 85 micron, using the techniques described in Example 1. The resulting films were evaluated as described above with respect to Example 1.

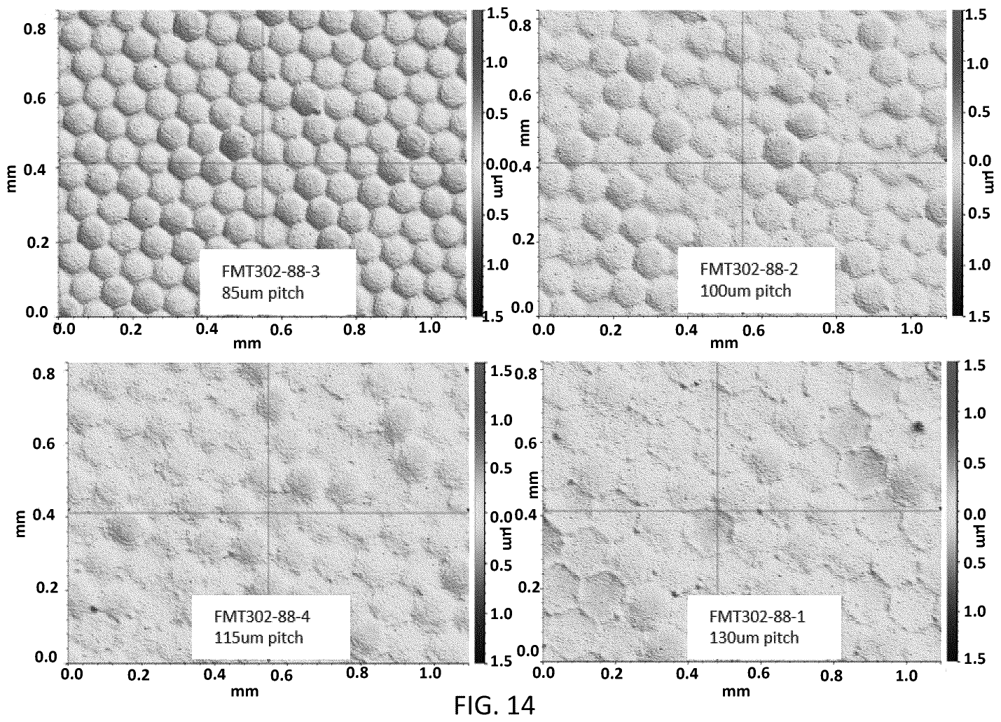

FIG. 14 shows Zygo surface profiles for the different pitch-sizes tested. All of the microcells showed bumps indicating that IP was sealed within the microcells. The microcells with the smallest pitch-size, i.e., 85 micron, had the highest bumps, indicating little to no drop-in.

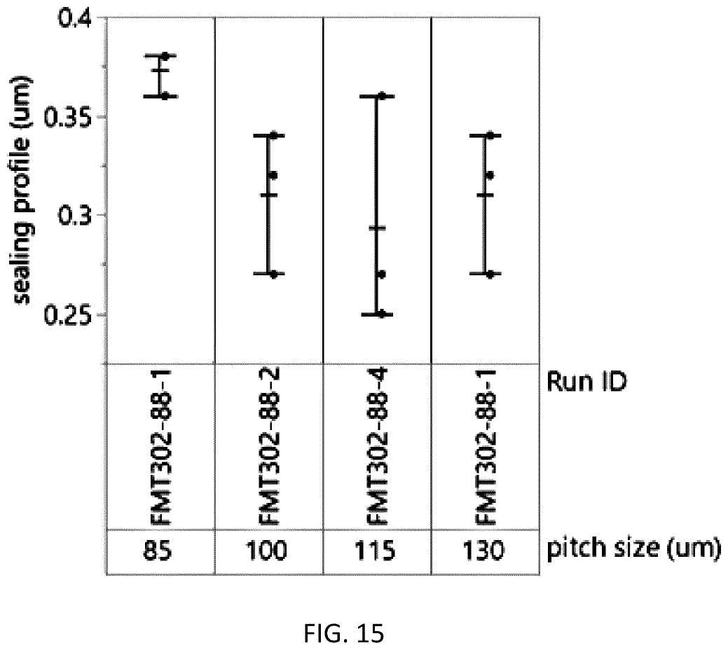

FIG. 15 shows the variability in sealing profile from the profile data of FIG. 14.

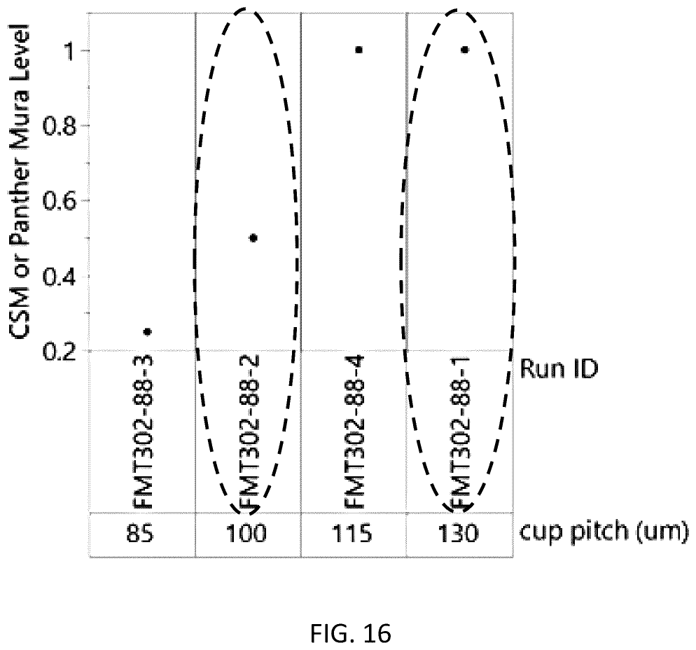

FIG. 16 shows the variability chart for cloudy spot mura (CSM) or panther mura level of the 130 μm, 115 μm, 100 μm, and 85 μm pitch microcells. CSM or panther mura is reduced for microcells with smaller pitch sizes, indicating that the sealing layer was of uniform thickness across the microcell opening.

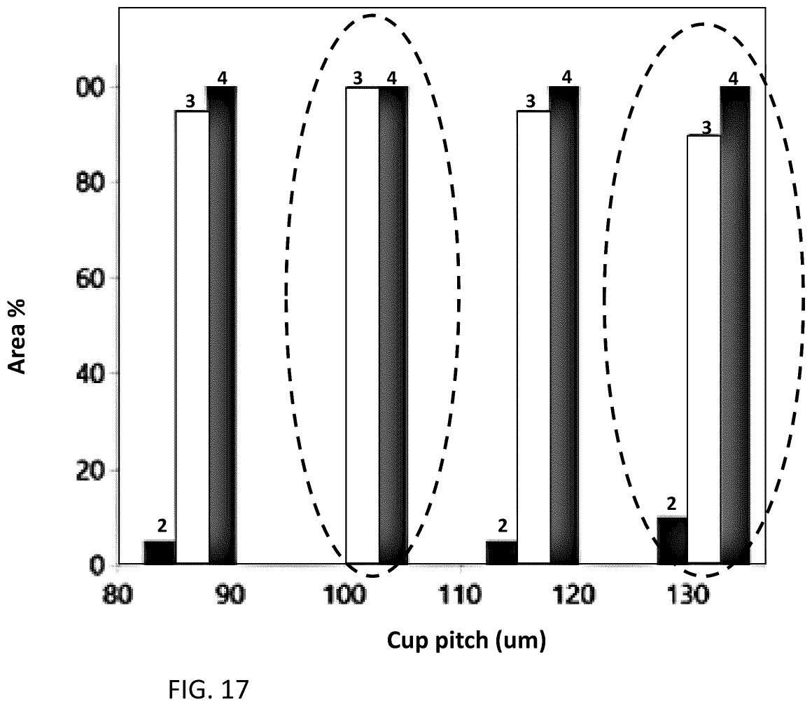

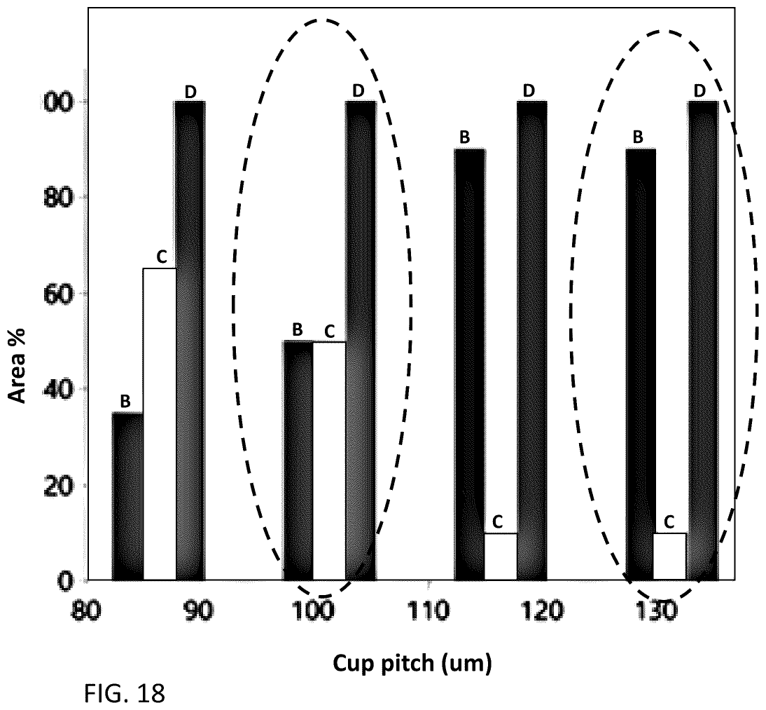

FIGS. 17 and 18 compare the amount of SDI for the microcells prepared with different atmospheric pressure (AP) plasma treatments. Potentially due to (a lack of) interactions with electrophoretic medium additives, all of the microcell samples of FIG. 17 were satisfactory, having good adhesion (reflected in high % peeled) and low levels of SDI. Increasing the flow rate of the gas for the plasma treatment (FIG. 18) resulted in better adhesion, but substantially worse SDI, especially for the larger pitch widths. That is, when the microcells were prepared with 200 lpm of nitrogen minimal SDI was observed for each of the four different microcells, but when the microcells were prepared with 300 lpm of nitrogen SDI was observed with all the pitch-sizes, but more than 80% of the 115 and 130 micron pitch-size cells had SDI. The smaller-pitch microcells showed a wider AP coating window and better overall coating quality. The data in FIGS. 14-18 suggest that reducing the pitch width results in a larger coating window for two different types of electrophoretic medium formulations filled and sealed in 8 μm deep microcell films.

### Example 4

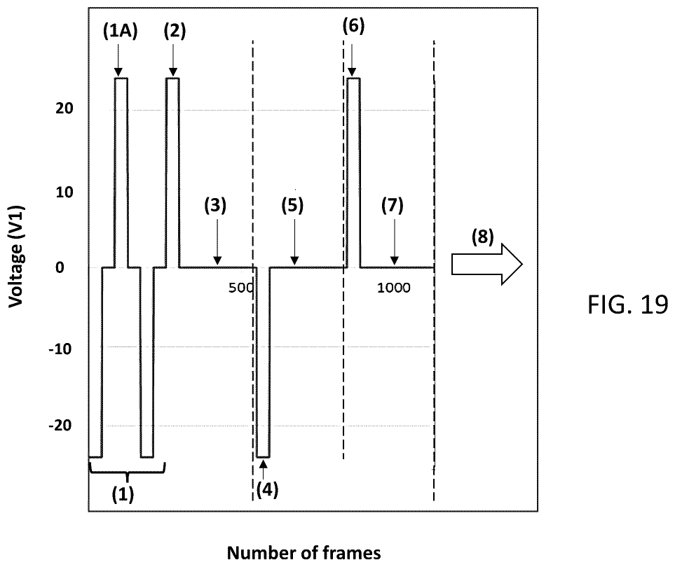

Switching speeds of microcells with different depths were also investigated. Microcells with 120 μm pitch size and two different depths (i.e., 6 μm and 8 μm) were filled with the same internal phase composition comprising subtractive cyan, yellow, and magenta particles paired with reflective white particles, (i.e., ACeP) and subsequently sealed. The performance of the microcells was investigated by connecting to a voltage driver which provides waveforms as shown in FIG. 19.

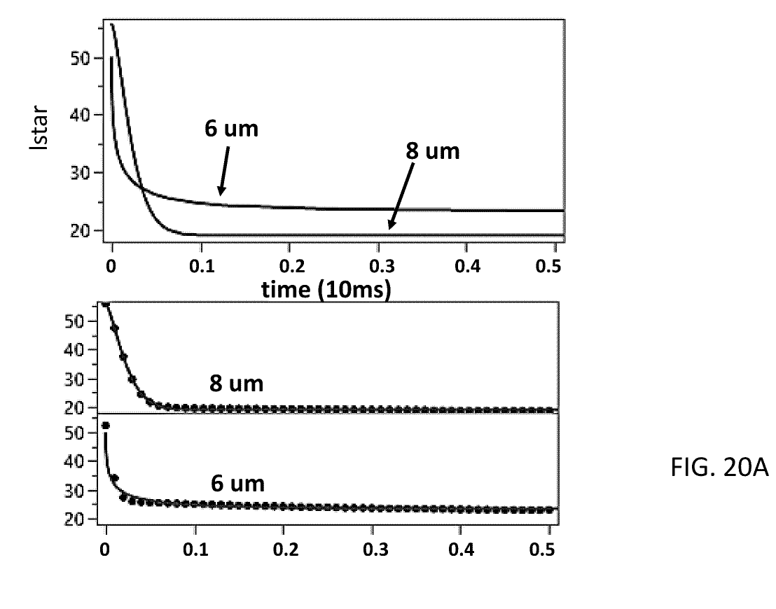

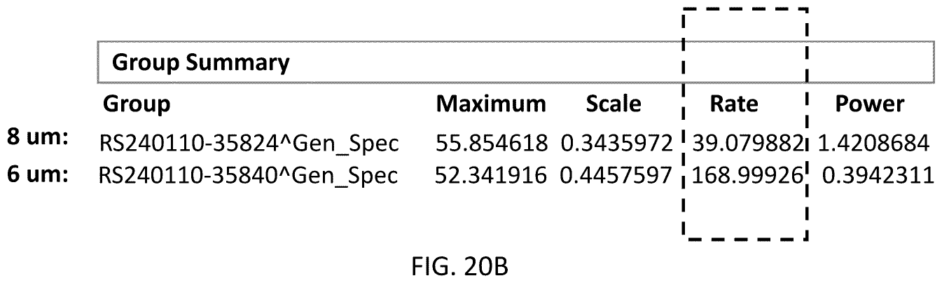

The L*, a*, and b* values were measured throughout the pulses and rests. The L* values were plotted as a function of time as the microcells were driven from white to black, shown in FIG. 20A. Microcells with 6 μm depth resulted in four times faster switching speed compared to microcells with 8 μm depth. L* vs time fitting parameters obtained using a fitting program (JMP) are shown in FIG. 20B. The increased speed allows the microcells to cycle from any first color to any second color in 350 ms or less. Such switching time allows for the production of all eight primary colors (i.e., red, green, blue, cyan, yellow, magenta, white, and black) consecutively within 3 seconds at every pixel of the display. Accordingly, microcells including an ACeP formulation and having a reduced cup depth and pitch are able to cycle through all of the eight primaries in less than three seconds. It is suspected that, in fact, with further improvements, this switching time can be reduced to under two seconds or faster.

What is claimed is:

1. An electrophoretic display comprising:
a light-transmissive top electrode;
an electrophoretic media layer including a film of microcells comprising partition walls and top-openings, wherein an electrophoretic fluid comprising at least four different kinds of charged pigment particles dispersed in a solvent fills the microcells, and a top-sealing layer that encloses the electrophoretic fluid within the microcells; and
a backplane electrode;
wherein the edge-to-edge distance of the top-opening of the microcells is in a range of 50 to 125 microns and the depth of the microcells is in a range of 3 to 15 microns.

2. The electrophoretic display of claim 1, wherein the display is capable of producing seven or eight independent primary colors within five seconds.

3. The electrophoretic display of claim 2, wherein the display is capable of producing seven independent primary colors, and the independent primary colors are black, white, red, orange, yellow, green, and blue.

4. The electrophoretic display of claim 2, wherein the display is capable of producing eight independent primary colors, and the independent primary colors are black, white, red, green, blue, magenta, yellow, and cyan.

5. The electrophoretic display of claim 1 wherein the electrophoretic fluid consists essentially of four different kinds of charged pigment particles.

6. The electrophoretic display of claim 5, wherein the electrophoretic fluid comprises first, second, and third kinds of subtractive pigment particles and a fourth kind of reflective pigment particles, wherein the four kinds of charged pigment particles are differently colored.

7. The electrophoretic display of claim 5, the electrophoretic fluid comprises first, second, and third kinds of reflective pigment particles and a fourth kind of semi-transparent pigment particles, wherein the four kinds of charged pigment particles are differently colored.

8. The electrophoretic display of claim 1 wherein the electrophoretic fluid has a total charged pigment particle loading of at least 40%.

9. The electrophoretic display of claim 1, wherein the microcells have a total severe drop-in (SDI) area of less than 20% of the total sealed microcell area.

10. The electrophoretic display of claim 1, wherein the edge-to-edge distance of the top-opening of the microcells is in a range of 85 to 115 microns or wherein the depth of the microcells is in a range of 5 to 10 microns.

11. The electrophoretic display of claim 1, wherein the edge-to-edge distance of the top-opening of the microcells is in a range of 85 to 115 microns and wherein the depth of the microcells is in a range of 5 to 10 microns.

12. The electrophoretic display of claim 1, wherein the top sealing layer comprises a polyvinyl alcohol.

13. The electrophoretic display of claim 1,
wherein the electrophoretic fluid consists essentially of four different kinds of charged pigment particles;
wherein the electrophoretic fluid comprises first, second, and third kinds of subtractive pigment particles and a fourth kind of reflective pigment particles, wherein the four kinds of charged pigment particles are differently colored or the electrophoretic fluid comprises first, second, and third kinds of reflective pigment particles and a fourth kind of semi-transparent pigment particles, wherein the four kinds of charged pigment particles are differently colored; and
wherein the display is capable of producing seven or eight independent primary colors within five seconds.

14. The electrophoretic display of claim 13, wherein the electrophoretic fluid has a total charged pigment particle loading of at least 40%.

15. The electrophoretic display of claim 13, wherein the microcells have a total severe drop-in (SDI) area of less than 20% of the total sealed microcell area.

16. The electrophoretic display of claim 13, wherein the edge-to-edge distance of the top-opening of the microcells is in a range of 85 to 115 microns and wherein the depth of the microcells is in a range of 5 to 10 microns.

17. The electrophoretic display of claim 13, wherein the top sealing layer comprises a polyvinyl alcohol.

18. A method for preparing an electrophoretic display comprising:
filling an electrophoretic media layer including a film of microcells comprising partition walls and top-openings with an electrophoretic fluid comprising at least four different kinds of charged pigment particles dispersed in a solvent and
sealing the electrophoretic media layer with a top-sealing layer that encloses the electrophoretic fluid within the microcells;
wherein the edge-to-edge distance of the top-opening of the microcells is in a range of 50 to 125 microns and the depth of the microcells is in a range of 3 to 15 microns.

19. The method of claim 18 further comprising forming the microcells comprising partition walls and top-openings.

20. The method of preparing the electrophoretic display according to claim 1 comprising:
filling the electrophoretic media layer including the film of microcells comprising partition walls and top-openings with the electrophoretic fluid comprising at least four different kinds of charged pigment particles dispersed in the solvent;
sealing the electrophoretic media layer with the top-sealing layer that encloses the electrophoretic fluid within the microcells; and
enclosing the sealed electrophoretic media layer between the light-transmissive top electrode and the backplane electrode.
